(19) United States
(12) Patent Application Publication
(10) Pub. No.: US 2026/0013437 A1
(43) Pub. Date: Jan. 15, 2026

(54) SYSTEMS AND METHODS FOR CONTROLLING AGRICULTURAL WORK MACHINE OPERATIONS

(71) Applicant: Deere & Company, Moline, IL (US)

(72) Inventors: Nathan R. VANDIKE, Geneseo, IL (US); James M. HERSHBARGER, LeClaire, IA (US)

(21) Appl. No.: 19/231,111

(22) Filed: Jun. 6, 2025

Related U.S. Application Data
(60) Provisional application No. 63/670,426, filed on Jul. 12, 2024.

(51) Int. Cl. A01D 41/127

(52) U.S. Cl. CPC A01D 41/1276

(57) ABSTRACT

An agricultural system includes one or more processors and memory storing instructions executable by the one or more processors, that, when executed, cause the agricultural system to: obtain first sensed data representative of one or more performance parameters; generate a command to adjust, by a first adjustment value, an operational parameter of the agricultural work machine; obtain second sensed data representative of the one or more performance parameters, the first sensed data generated prior to the adjustment and the second sensed data generated after the adjustment; compare the one or more performance parameters of the agricultural work machine, represented by the first sensor data, to the one or more performance parameters of the agricultural work machine, represented by the second sensor data; generate a threshold target value for use in adjusting the operational parameter based on the comparison; and control the agricultural work machine based on the threshold target value.

### CROSS-REFERENCE TO RELATED APPLICATION

The present application is based on and claims the benefit of U.S. Provisional Patent Application Ser. No. 63/670,426 filed, Jul. 12, 2024, the content of which is hereby incorporated by reference in its entirety.

### FIELD OF THE DESCRIPTION

The present description relates to agricultural work machine operations. More specifically, the present description relates to agricultural work machine operations, monitoring characteristics relative to the agricultural work machine operation, and controlling an agricultural work machine.

### BACKGROUND

There are a wide variety of different types of agricultural work machines. One such example agricultural work machine is an agricultural harvester (also called harvester) that performs, as an agricultural work machine operation, harvesting in which the harvester is used to harvest various crops, such as different types of grain crops, at a worksite (e.g., field). While harvesting a crop, the harvesters may also generate residue, which includes harvested material other than grain (MOG). Some harvesters include residue monitoring systems to monitor crop residue generated by the harvester. The residue monitoring systems may be used to adjust future field harvesting operations based upon an analysis of the collected information. However, while harvesting, operating conditions of a harvester can produce variable response characteristics of harvester controls and components, such as those used for residue processing (e.g., chopping, spreading, etc.). As an example, small changes in the knifebank position of a residue chopper may result in little to no change in actual straw length of the residue but may result in a disproportionate change in power consumption.

The discussion above is merely provided for general background information and is not intended to be used as an aid in determining the scope of the claimed subject matter.

### SUMMARY

An agricultural system includes one or more processors and memory storing instructions executable by the one or more processors. The instructions, when executed by the one or more processors, cause the agricultural system to: identify that a responsiveness evaluation is to be conducted, based on responsiveness evaluation criteria; obtain first sensed data representative of one or more performance parameters of the agricultural work machine; generate, in response to the identification that the responsiveness evaluation is to be conducted, a command to adjust, by a first adjustment value, an operational parameter of the agricultural work machine; obtain second sensed data representative of the one or more performance parameters of the agricultural work machine, wherein the first sensed data is generated prior to the adjustment to the operational parameter of the agricultural work machine and wherein the second sensed data is generated after the adjustment to the operational parameter of the agricultural work machine; compare the one or more performance parameters of the agricultural work machine, represented by the first sensor data, to the one or more performance parameters of the agricultural work machine, represented by the second sensor data; generate a threshold target value for use in adjusting the operational parameter of the agricultural work machine based on the comparison; and control the agricultural work machine based, at least, on the threshold target value.

One or more techniques and/or systems are disclosed for controlling one or more systems of a harvester, such as a residue system of the harvester to achieve a desired chopping quality, while providing for a desired (e.g., efficient) amount of power consumption by the system. That is, adjustments to the residue system, such as changing the knifebank to provide for a more aggressive chop, or adjusting the rotor speed of the chopper, can have an impact on the power consumption of the residue system, and thereby the harvester. Operational data (e.g., data generated during an operation) can be monitored, and predictive data can be generated, to identify potential changes in the residue chopping quality with regard to the power consumption. The residue system may need to be periodically adjusted to meet a desired residue chopping quality, and these changes can affect the power consumption. In order to meet a desired operation profile that provides the preferred chopping quality (e.g., within a range), while providing for a preferred power consumption (e.g., within a range), a control unit can update an adjustment threshold in real-time, and update a system adjustment sensitivity in real-time.

In one implementation, a crop residue control system for a crop harvester can comprise one or more sensors that are configured to provide sensed data representative of one or more operational parameters of a harvester operation, and to provide sensed data representative of one or more performance parameters of the harvester operation, wherein operational parameters are indicative of operation of one or more systems of the harvester, and performance parameters are indicative of results of the harvester operation. A control unit can receive input data, comprising the sensed data. In this implementation, the control unit comprises a processor for processing instructions and data. The control unit further comprises memory that stores instructions and an operation profile that is representative of preferred operational parameters of the one or more systems of the harvester, such as the residue system, and representative of a desired operational performance (performance parameters) for the harvesting operation, such as a preferred residue chopping quality.

When executed by the processor the instructions are configured to: use the input data to identify changes in the operational parameters of the harvester over time; use the input data to identify changes in the performance parameters (e.g., residue chopping quality) over time; compare the changes in the operational parameters of the harvester with the changes in the performance parameters (e.g., residue chopping quality); and determine a threshold target value for a control system operation for the harvester, wherein the threshold target value is representative of a performance profile that is indicative of a target operational parameter of the harvester and a target performance parameter, and wherein the control system operation for the harvester controls operation of the one or more systems of the harvester. In this implementation, the control unit further identifies changes to the operational parameters of a harvester that, when executed, are used to meet the threshold target value for the control system operations (e.g., performance parameters) for the harvester. Additionally, the identified changes to the operational parameters of a harvester are executed.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

The examples disclosed herein may take physical form in certain parts and arrangement of parts, and will be described in detail in this specification and illustrated in the accompanying drawings which form a part hereof and wherein:

FIG. 1 is a component diagram illustrating a perspective view of a harvester according to an implementation of one or more portions of one or more systems described herein.

IG. 2 is a component diagram illustrating a perspective view of a residue system according to an implementation of one or more portions of one or more systems described herein.

FIG. 3 is a schematic diagram illustrating one example implementation of a system for controlling a residue chopping system by determining the response sensitivity.

FIG. 4 is a component diagram illustrating a perspective view of a harvester according to an implementation of one or more portions of one or more systems described herein.

FIG. 5 is a flow diagram illustrating an example method for controlling one or more harvester systems by determining the response sensitivity.

FIG. 6 is a flow diagram illustrating another example method for controlling one or more harvester systems by determining the response sensitivity.

FIG. 7 is a block diagram of one example of the system 300.

FIG. 8 is a schematic block diagram illustrating an exemplary computing system that may be used by one or more portions of one of more systems described herein

FIG. 9 is a block diagram showing one example of items of system 300 in communication with a remote server architecture.

FIGS. 10, 11, and 12 show examples of mobile devices that can be used in the system 300.

FIG. 13 is a block diagram showing one example of a computing environment that can be used in the system 300.

### DETAILED DESCRIPTION

For the purpose of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example can be combined with the features, components, and/or steps described with respect to other examples of the present disclosure.

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

Traditional control systems for agricultural operations, such as harvesting operations, will monitor sensor signals of a characteristic of interest of a an agricultural work machine (e.g., harvester, etc.) or agricultural operation (e.g., harvesting operation), and will make decisions whether to make adjustments to operational parameters of the agricultural work machine (e.g., harvester) based on whether those signals (or values thereof or indicated thereby) meet certain thresholds. For example, thresholds for a minimum or maximum value of the sensor signal, or thresholds for a difference or change in the signal can be set as fixed values from the factory or set by an operator to their preference. The control system will determine if the signals (or values thereof or indicated thereby) meet or exceed the thresholds, and make adjustments to the operational parameters, such as by generating an adjustment command. Those adjustments are typically some fixed value for adjusting an operational parameter Fixed values for adjusting operational parameters may not be sufficient to bring about desired performance parameters, particularly in inconsistent operational environments.

Operational environments of an agricultural work machine (e.g., harvester) are not consistent, for example, the crop properties are not the same year to year, field to field, or even in a single field. Sometimes this results in adjustments of the operational parameters, using a generated adjustment command, producing different responses of the sensor signals for the characteristic of interest. For example, a small change in an operational parameter (e.g., setting) can produce a large change in response of characteristics sensor signal (e.g., large change in response of a sensed performance parameter). Alternatively, it may take several changes in the operational parameter to get any change in the characteristic's sensor signal. This can be a problem for control systems using fixed thresholds because control systems may end up making changes in operational parameters (e.g., settings) that cause an over-reaction of the system (e.g., a single adjustment causes a large response, therefore over shooting the intended correction and causing a problem in the opposite direction) or an under-reaction of the system (e.g., many adjustments are needed to get a small response, therefore taking many adjustments and time to get to the intended value of the signal).

Methods and systems disclosed herein are devised to understand what the agricultural work machine systems (e.g., harvester systems) can actually respond to, and how much influence an adjustment may have on a sensor signal response (e.g., on a performance parameter). The relationship of the adjustment to the response for a given environment can be learned and a control system can, thereby, be more effective in making decisions.

The methods and systems disclosed herein, for example, may be suitable for use in different agricultural work machine applications for example, but not by limitation, harvester applications, such as those that also distribute residue back to the field during harvesting. That is, the herein disclosed examples can be implemented in different agricultural work machines including different harvesting equipment, for different types of harvested crops. In these implementations, the control of adjustment sensitivity to an operation system in the agricultural work machine (e.g., harvester) is provided.

A system may be devised to improve the controlling of various systems of an agricultural work machine (e.g., harvester), such as a residue system in a harvester, by determining a response sensitivity of adjustments made to the control system operations of the harvester during a harvesting operation. Example systems described herein can implement a controller that is used to adjust operational parameters of various agricultural work machine systems, for example, various harvester systems, such as the residue system operation, for example, by adjusting the chopper knifebank position, chopper speed, the rotor speed and concave clearance, and the feed rate. Further, the controller can be configured to identify locations in a field where responsiveness evaluations can be performed, based on responsiveness evaluation criteria which can include, among other things, field conditions, terrain, and variability identified in the field. The controller can also be used to identify, as responsive evaluation criteria, certain times or time intervals when the sensitivity evaluations should be performed. Additionally, a sensor array in/on the agricultural work machine (e.g., harvester) can comprise sensors for identifying operating characteristics (e.g., performance parameters), for instance, in the example of a harvester, performance parameters such as chopping quality of the crop, and chopping power used to achieve the chopping quality.

The system can also be devised to perform an analysis of measured values of the performance parameters of an agricultural work machine, and its various systems, for instance performance parameters of a harvester, and its various systems, such as the residue system. The analysis can be performed based on changes in the values of the performance parameters as adjustments are made to the operating parameters. The analysis can provide a threshold target value for the control system for operation of the agricultural work machine (e.g., harvester) and various systems. Further, the controller can receive the threshold target value for use as an action threshold. The controller may monitor the system's operation, using data provided by the one or more sensors. During monitoring, when the various agricultural work machine (e.g., harvester) performance parameter sensor values change, and they are not within the threshold targets established by the analysis, the controller can adjust operational parameters of the agricultural work machine (e.g., harvester).

Generally, the systems and methods described here can use sensor data identifying the responsiveness of an adjustment (e.g., adjustment to operational parameters) made to the agricultural work machine (e.g., harvester) or to component thereof (e.g., residue system), and results of any changes from subsequent measured values (e.g., measured values of performance parameters), to determine the threshold targets of the control system. Monitoring can be performed to identify changes in the agricultural work machine (e.g., harvester) performance parameters in the field during an operation. Adjustments can be made to the operational parameters (e.g., settings) based on the threshold determined through the analysis. The resulting threshold values can be used to make appropriate adjustments to the operational parameters of the systems of an agricultural work machine, for instance, appropriate adjustments to the operational parameters of an agricultural work machine (e.g., harvester) or a system thereof (e.g., residue system) as needed.

In one implementation, in one aspect, the system can comprise a control subsystem. The control subsystem can comprise at least one sensor configured to detect a characteristic of interest, for instance, a characteristic related to work machine (e.g., harvester) operations such as work machine performance parameters, or other characteristics. An analysis module can be configured to analyze the sensor signal from the sensor; and a set of instructions (e.g., in memory of a control unit) can determine an action threshold at which an adjustment to an operational parameter should take place by performing a responsiveness evaluation. The controller can be used to adjust the operational parameters of the machine operation, making decisions based on the action threshold determined by the instructions.

In this implementation, the system can further be configured to determine the action threshold by adjusting an operational parameter of the machine and monitoring the sensor signal (e.g., sensed performance parameter) response to the adjustment. Then the system can identify a relationship between the signal response (e.g., sensed performance parameter/change thereof) and the operational parameter. Further, the system can determine the action threshold, based on responsive evaluation criteria, such as a fixed set of time or a fixed amount of distance or area worked (e.g., harvested), a fixed amount of crop material that is operated on (e.g., harvested), variability or consistency of conditions at locations in the field.

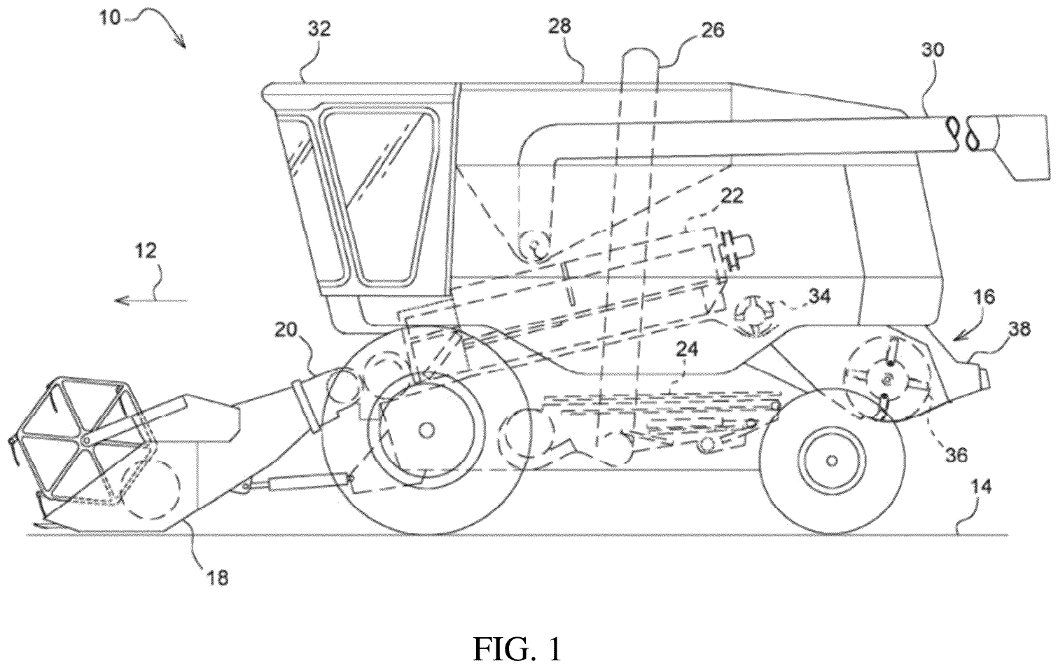

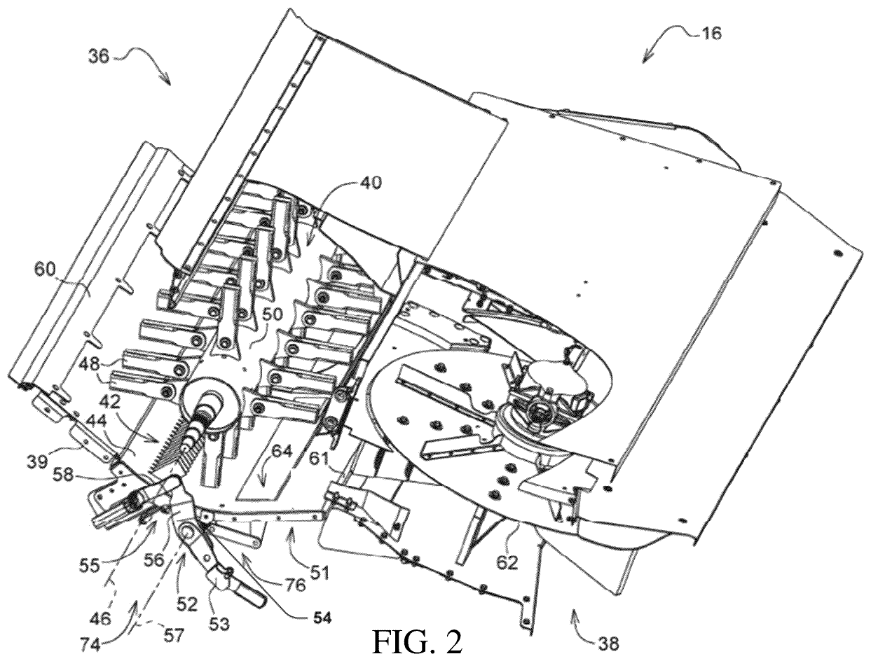

FIGS. 1 and 2 are component diagrams illustrating one example environment where one or more of the systems and methods described herein may be implemented. FIG. 1 illustrates one example of an agricultural work machine as an agricultural harvester 10, which is configured to move in a forward direction of travel 12 over a field 14 to harvest crop from the field 14. The harvester 10 processes the crop, separating grain from crop residue (e.g., straw, stalks, cobs, leaves, chaff). The harvester 10 includes a residue management system (or residue system) 16 for returning crop residue, derived from harvested crop, back to the field 14.

In general, the harvester 10 can include an implement 18 to cut, gather, and move the crop to the harvesting subsystems, a feederhouse 20 to advance crop received from the implement into the body of the harvester 10, a threshing and separating section 22 to thresh crop and further separate grain from crop residue, a cleaning section 24 including one more chaffers and sieves to separate grain from chaff or other relatively small pieces of crop material, a clean grain elevator 26 to elevate clean grain to a storage bin 28, an unloader 30 to unload clean grain from the storage bin 28 to another location, and a beater 34 to beat residue that is received from the threshing and separating section 22 and does not pass to the cleaning section 24 (e.g., straw, stalks, cobs, leaves), and move it rearward. A person can control the harvester 10 from an operator's station 32 of the harvester 10. The harvester 10, including such portions thereof, can be configured in a wide variety of ways.

FIG. 2 illustrates one example of a residue management system 16, which includes a chopper 36 and a residue spreader 38. The chopper 36 chops crop residue derived from the crop harvested from the field 14 by the harvester 10. The residue spreader 38 is positioned rearward of the chopper 36. In some examples, the residue spreader 38 can be mounted for pivotable movement relative to the chopper 36 between a dispersal position to disperse crop residue received from the chopper 36 onto the field 14 and a windrow position to deposit crop residue received over the residue spreader from the harvester onto the field 14 in a windrow. In other examples, the residue spreader 38 can be mounted in a fixed position relative to the chopper 36.

The chopper 36 can receive crop residue from the threshing and separating section 22 and the cleaning section 24. In some examples, the harvester 10 includes a door that is closed to direct crop residue from the threshing and separating section 22 and the beater 34 to the chopper 36 for chopping when the residue spreader 38 is positioned in the dispersal position. When the residue spreader 38 is positioned in the windrow position, the door is open to direct crop residue from the threshing and separating section 22 and the beater 34 over the top of the residue spreader 38 to deposit crop residue onto the field 14 in a windrow. In some examples, the chopper 36 can receive crop residue in the form of, for example, chaff from the cleaning section 24 in one or both of the dispersal position and the windrow position.

In this example implementation, the chopper 36 includes a housing 39, a rotor 40, and a bank of counter-knives 42. The rotor 40 is mounted to the housing 39 and positioned in an interior region 44 of the housing 39 for rotation therein about an axis of rotation 46 relative to the housing 39. The rotor 40 includes blades 48 that interact with the bank of counter-knives 42 (also known as a knifebank) to chop crop residue upon rotation of the rotor 40 about the axis of rotation 46 in a chopping direction 49. The blades 48 are mounted about the periphery of a hub 50 of the rotor 40. In this example, the rotor is a flail rotor, such that the blades 48 are flail blades; although other implementations are anticipated.

The bank of counter-knives 42 is movable relative to the rotor 40 to adjust a chopping aggressiveness of the chopper 36 (e.g., to adjust chopping aggressiveness—resulting in a change in size of chopped residue). The bank of counter-knives 42 is movable relative to the rotor 40 and the axis of rotation 46 between at least two or more operational positions, respectively defining engagement positions of the knifebank. As illustrated, the counter-knives 42 can extend through corresponding slits in an chopper floor 51 of the housing 39 to extend alternatingly between the blades 48 to promote chopping of crop residue that enters the interior region 44. Greater extension from the chopper floor 51 into the interior region 44 corresponding to more engagement and thus more chopping (e.g., changing chop size). The bank of counter-knives 42 move in a linear manner toward and away from the rotor 40 and its axis of rotation 46 between engagement positions. In other examples, the bank of counter-knives 42 could be configured to move into various in-between engagement positions (e.g., pivotally).

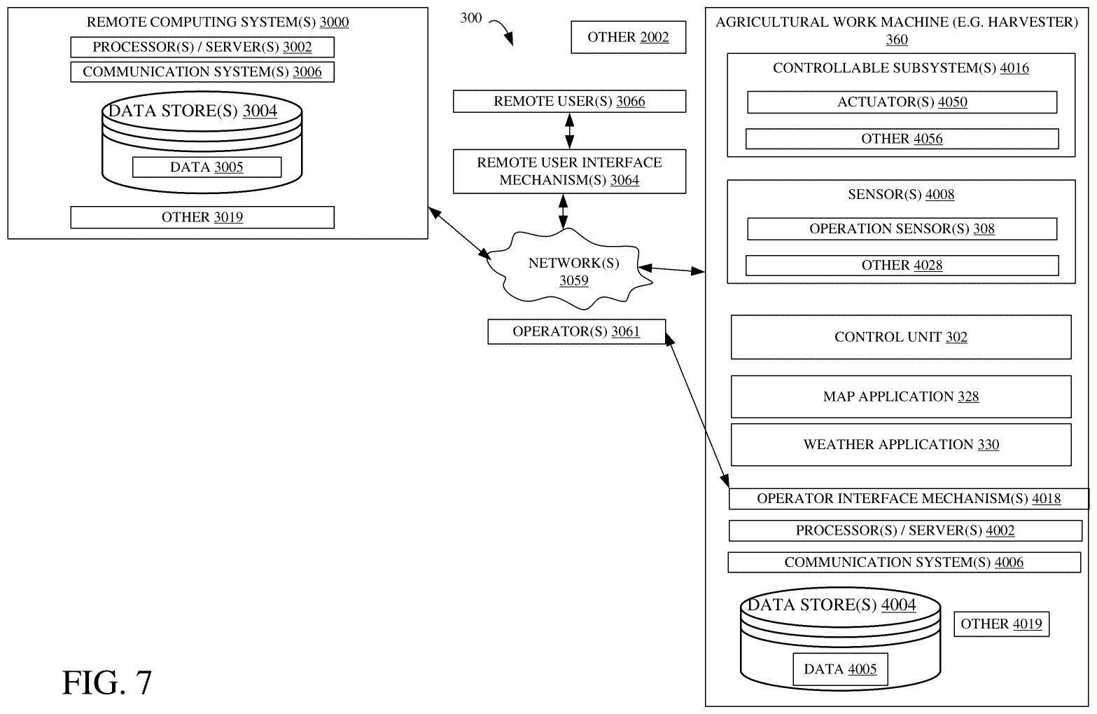

The chopper 36 includes a knife actuator 52 to adjust the engagement position of the bank of counter-knives 42. The knife actuator 52 is operable to move the bank of counter-knives 42 between the various operational positions. In this example, the knife actuator 52 is manually operable to move the bank of counter-knives 42 between operational positions. However, it is anticipated that a remotely operated actuator (e.g., shown in FIG. 7) can be used to move the bank of counter-knives 42 between the various operational positions. In those implementations, a remotely operated, powered actuator can be engaged with the knifebank to move the bank of counter-knives 42 between operational positions. In the illustrated example, the knife actuator 52 includes a handle 53, a rotatable shaft 54, and a linkage 55. The shaft 54 rotates therewith about an axis of rotation 57 of the shaft 54. The linkage 55 includes a second link 58 pivotally coupled to the first link 56, and the component is coupled to the bank of counter-knives 42. The knife actuator 52 also includes another linkage 55 and sliding element similarly configured and arranged at the opposite end of the bank of counter-knives 42. To change the operational position of the bank of counter-knives 42, an operator can move the handle 53 causing the shaft 54 to rotate about the axis 57 and the linkages 55, in the corresponding slots, to move the bank of counter-knives 42 linearly between positions. Alternately, this action can be automated with automated actuators.

The housing 39 includes a residue inlet 60 and a residue outlet 61. Crop residue from the threshing and separating section 22 and beater 34 can enter the chopper 36 through the residue inlet 60 into interior region 44. Crop residue can exit the chopper 36 from the interior region 44 through the residue outlet 61 to the residue spreader 38.

In some examples, the residue spreader 38 includes a right spreading device 62 and a left spreading device (not shown, similar to 62) laterally adjacent to the right spreading device 62 (only right spreading device 62 shown). Each spreading device 62 is configured to disperse crop residue onto the field 14 when the residue spreader 38 is positioned in the dispersal position. The spreading device 62 can be configured and operated in a wide variety of ways. For example, illustratively, the spreading device 62 includes an impeller with a rotating disk and paddles depending therefrom for dispersing crop residue from the residue spreader 38.

The operational position of the bank of counter-knives 42 can affect the trajectory of crop residue through the residue outlet 61 relative to the residue spreader 38. The chopper 36 tends to direct crop residue more at the residue spreader 38 and its spreading devices 62 with increased chopping aggressiveness of the bank of counter-knives 42 (e.g., increased engagement). The outlet floor 51 of the chopper 36 can be configured to manage the trajectory of crop residue relative to the residue spreader 38. In some implementations, the chopper floor 51 can include one or more ramps 64. The ramps 64 can be longitudinally aligned relative to one another, so as to collectively, span a width of the interior region 44.

For example, each ramp 64 can be positioned downstream from the bank of counter-knives 42 relative to the chopping direction 49. The ramp 64 is movable relative to the rotor 40 and the axis of rotation 46 between a number of ramp positions to manage the trajectory of crop residue relative to the residue spreader 38. The chopper 36 includes an adjuster 74. The adjuster 74 is coupled with the bank of counter-knives 42 and the ramp 64 to position the ramp 64 in correspondence with the operational position of the bank of counter-knives 42. The adjuster 74 positions the ramp 64 in the various ramp positions. The adjuster 74 comprises the knife actuator 52 and a ramp actuator 76.

It should be noted that these illustrations and descriptions are used to illustrate the operations of a harvester and residue system, which can be used in conjunction with the systems and methods described herein. While the examples provided illustrate merely one type of harvester and residue system, it is anticipated that other types of harvesters and harvester systems may be utilized with the innovative concepts described herein. The methods and systems disclosed herein, for example, may be suitable for use in different harvesters and harvesting applications. That is, disclosed examples can be implemented in different harvesters and residue systems to analyze operational parameters that affect residue disbursement, which can result in improved performance to determine when operational parameter changes are needed. For example, one or more described examples may allow for improved analysis of the operation of the residue system with regard to the resulting residue performance (e.g., chopping quality, residue spread quality, etc.), and while monitoring the power output for the harvester. As such, improved real-time residue system adjustments can be made to achieve the desired residue performance (e.g., chopping quality, residue spread quality, etc.), while meeting desired power outputs.

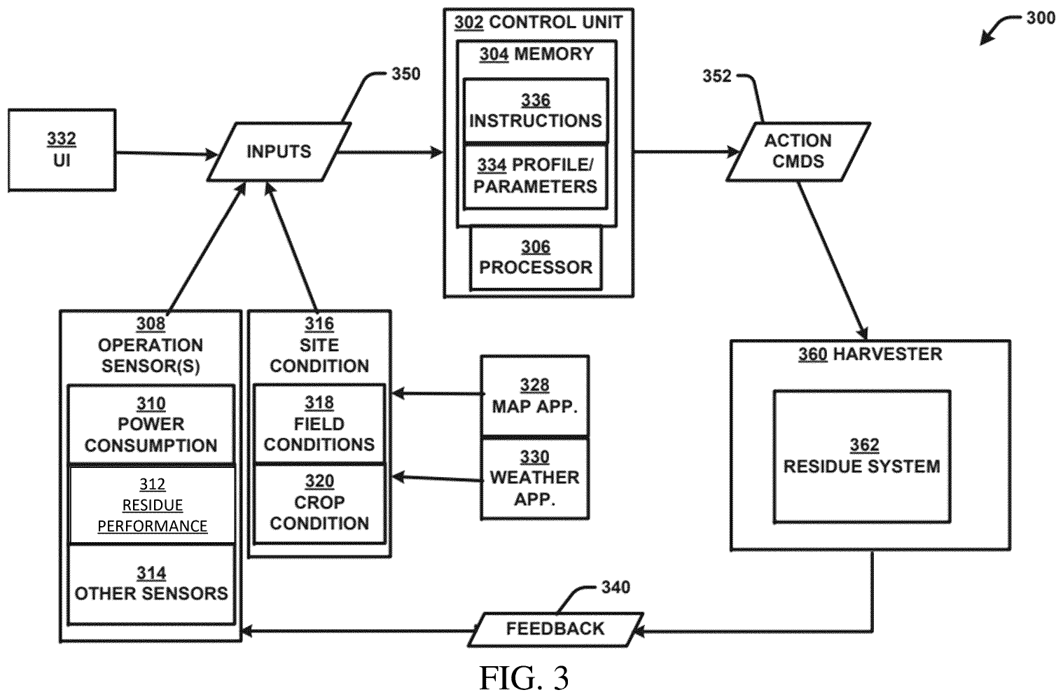

FIG. 3 is a schematic diagram that illustrates one implementation of an example system 300 for controlling a system of an agricultural work machine, illustratively, a residue system in a harvester, in real-time resulting in improved efficiency of the system operation (e.g., residue chopping, residue spreading, etc.) with a desired performance (e.g., residue performance such as chopping quality, residue spread quality, etc.). The example system 300 can comprise a control unit 302 (e.g., a controller), which comprises memory 304 and a processor 306. The control unit 302 receives data representative of inputs 350 and provides data indicative of action commands 352 to equipment/components in the agricultural work machine and/or systems thereof, to make adjustments to the performance of the systems and/or adjustments to the power consumption based, at least, on the inputs. For example, as illustrated in the example of FIG. 3, the control unit 302 receives data representative of inputs 350 and provides data indicative of action commands 352 to equipment/components in the harvester and/or residue system (e.g., 10 and 16 of FIGS. 1 and 2) to make adjustments to the residue performance (e.g., chopping quality, residue spread quality, etc.), and/or power consumption, based at least on the inputs 350.

It should be noted that, while the illustration indicates a single control unit for the purpose of clarity of description, the control unit 302 may be comprised of distributed components. For example, a portion of the control unit 302 (e.g., a first portion) can be disposed at a central processing location, such as in a main computing center of the agricultural work machine (e.g., harvester), in the operator cab, engine compartment, etc., while another portion of the control unit (e.g., a second portion) can be disposed in/on or proximate the components of the agricultural work machine, such as in/on or proximate the residue system of a harvester. In this way, some input data 350 may be received at the second portion, while other input data 350 may be received at the first portion, for example. As another example, a first portion of the control unit can comprise a monitoring system (e.g., with sensors) that monitors input data that is indicative of operational parameters and resultant performance parameters (e.g., performance of a residue system and a power system of a harvester), and a second portion can comprise a control system that analyzes the input data and controls the systems of the agricultural work machine, such as residue system and/or other portions of the harvester, based on information provided by the monitoring system and a desired result.

In some implementations, input data 350 can comprise variables that are measured or sensed during operation, such as power consumption, and residue performance (e.g., chopping quality, residue spread, etc.) relative to a desired or target result. Other input data 350 can include a location in a field (e.g., for identifying field conditions, terrain, crop variability at that location), and input timing (e.g., time and measurement intervals). As an example, operation sensors 308 can include those that collect data during an operation (e.g., harvesting). In this example, power consumption can be measured during operation using a power consumption sensor 310 that detects the power used by the agricultural work machine and/or systems thereof, for instance, the power used by a harvester and/or by the residue system. That is, for example, the agricultural work machine (e.g., harvester) generates power that can be directed to and used by various components in the agricultural work machine (e.g., harvester). For example, power directed to or consumed by the residue system of a harvester can be detected during operation and used as input data 350.

A residue performance (e.g., chopping quality, residue spread quality, etc.) sensor 312 can be disposed in or proximately to the residue system to measure the residue performance (e.g., chopping quality, residue spread quality, etc.) during operation. For example, an image sensor (e.g., a device that captures and can process images in any form) can be mounted in or near the residue system to capture images of the chopped residue, and used to identify the condition of the chopped residue (e.g., size, shape, density) and/or the spread of the chopped residue (e.g., spread width, distribution, etc.). Data generated by these one or more sensors can be part of the input data 350 received by (e.g., sent to, or polled from the sensors by) the control unit 302. In some implementations, other sensors can be used to provide data used as the input data 350 to determine potential operational parameter adjustments, such as potential operational parameter adjustments for the residue system. For example, with respect to use in determining potential operational parameter adjustments for the residue system, other sensors 314 can collect operational data indicative of residue system rotor speed, knifebank position (e.g., operational position), harvester grain load, load on the system, such as threshing rotor pressure, harvester ground speed, etc. (e.g., operational parameters of the harvester during operation).

Further, site condition data 316, can include field conditions 318, such as, for example, terrain, soil conditions, weather, etc., and crop conditions 320, such as crop density, historical crop yield data, normalized vegetation difference index (NDVI) information. As an example, field condition data can be provided by a mapping application 328 and/or a weather application 330. These applications may be resident in memory (e.g., such as the memory 304 of the control unit 302) in the system 300, or may be operating on a separate computing device communicatively coupled with the system 300. For example, the mapping application 328 can comprise pre-programmed maps of the target crop area, with pre-identified terrain conditions of the operational area (e.g., satellite imagery, elevations, soil conditions, etc.). Further, the weather application 330 can provide real-time and predicted weather conditions for the operational area. The data generated/provided by these applications 328, 330 can be part of the input data 350 to the control unit 302. In some implementations, field condition data 318 can be collected in real-time with other sensors 314, such as a weather sensor (e.g., wind gauge, rain gauge, humidity sensor, moisture detector, etc.), and/or one or more terrain sensors (e.g., detecting pitch and roll of the harvester, moisture conditions of the soil, etc.). The field conditions data 318 generated by the respective sensors can be part of the input data 350 to the control unit 302.

In these implementations, crop condition data, indicating crop conditions 320, can be provided by a combination of sensors (e.g., other sensors 314), and pre-programmed information provided by one or more applications operating in/on the control unit 302. For example, NDVI data and crop density can be provided by satellite imagery, and/or by sensors in the harvester collecting real-time imagery of the crop, density of the crop feeding into the harvester, and bulk flow of the crop through the harvester using pressure and density sensors. In some examples, crop condition data can be provided by the mapping application 328. For example, the mapping application 328 can comprise pre-programmed maps of the target crop area, with pre-identified crop conditions of the operational area (e.g., satellite imagery, NDVI data, crop density, etc.).

In some implementations, the data inputs 350 can comprise or be indicative of information provided by an operator using a user interface 332 (UI) which the operator can use to input data, instructions, updates, programming, etc. As an example, the operator can use the UI 332 to input a desired residue performance, such as chopping quality (e.g., size, shape, density) for the residue chopping or residue spread quality (e.g., width, distribution, etc.) for the residue spreading, update data used to influence residue performance (e.g., operational parameters of the harvester), type of crop, and other data that may affect residue performance (e.g., chopping quality of the residue, spread quality of the residue, etc.).

The control unit 302 can receive the input data 350 and use it to generate the action commands 352 (e.g., adjustment commands), such as to make adjustments to the residue system and/or components thereof. For example, make adjustments to the knifebank (e.g., bank of counter-knives 42 of FIG. 2), based on the operation of the residue system (e.g., 16 of FIGS. 1 and 2). As another example, the control unit 302 can receive the input data 350 and use it to update one or more thresholds that are used to determine if/when changes to the system should be made. That is, for example, adjusting the system knifebank 42 (e.g., small adjustments) may have little to no effect on the chopping quality of the residue; however, that adjustment may have a disproportional effect on the power consumption of the residue system. In this example, the amount of additional amount of power consumed may not justify the small change to the chopping quality.

As such, a threshold or threshold range can be devised that may comprise a function (e.g., a ratio) of residue performance (e.g., chopping quality, residue spread quality, etc.) to power consumption that provides a desired residue performance (e.g., chopping quality, residue spread quality, etc.) while meeting a desired power consumption. In this example, if a harvesting operation condition (e.g., field, crop, weather, etc.) results in a change to the residue performance (e.g., chopping quality, residue spread quality, etc.) and/or power consumption outside of the threshold/range, an appropriate adjustment can be made to the system, and/or to the threshold. In this way, a continuous feedback loop is performed that can continually update the system during an operation to achieve a desired efficiency for residue performance (e.g., residue chopping quality, residue spread quality, etc.) and power consumption. In some implementations, the threshold or threshold range, can be configured to achieve a target efficiency, which accounts for a desired power consumption (e.g., least feasible), while achieving the desired residue performance (e.g., residue chopping quality, residue spread quality, etc.) for the residue (e.g., highest feasible for conditions). As an example, the threshold range may be evaluated based at least on the characteristics of the residue, such as residue length, residue spread width, and residue composition (e.g., using image data); the engine power used, the ground speed of the harvester; the torque or power provided to the residue system, loss of grain, and the quality of the grain, amongst other things. The threshold(s) should be able to provide the target quality for harvesting of the grain and processing (e.g., chopping, spreading, etc.) of the residue, while utilizing the lowest feasible amount of power.

In some implementations, the memory 304 can comprise instructions/programming 336 that identifies agricultural operation (e.g., harvesting) operation conditions (e.g., field, crop, weather, etc.) that may affect the performance, such as residue performance (e.g., residue chopping quality, residue spread quality, etc.), and power consumption based on the operation of the system (e.g., residue system) and the input data 350. Further, the instructions/programming 336 can be used to determine changes or adjustments (e.g., using adjustment or action commands) to the agricultural work machine (e.g., harvester) operational parameters (e.g., residue system operational parameters) and/or to the target thresholds to meet pre-determined performance parameters (e.g., desired efficiency ranges, desired residue performance, etc., stored in memory 304) for operation of the agricultural work machine (e.g., harvester) systems (e.g., the chopping and/or spreading of the residue by the residue system). For example, the operator (e.g., or a pre-programmed operational guidance system) may set a desired residue performance (e.g., residue chopping quality, residue spread quality, etc.) characteristic based on the target crop, expected field conditions, expected crop conditions, type of equipment, etc. (e.g., an operation profile 334). That is, typically, the operator may wish to have a particular size, shape, density, and spread (e.g., width and/or distribution) of the residue across the harvested field. In these implementations, the operator can enter an initial operation profile 334 as input data 350 to the control unit 302, using the UI 332.

In some implementations, the operation profile 334 can be preset by an agricultural operation (e.g., harvesting) operations program, or may be set by the operator. In these implementations, the operational parameters for the system (e.g., residue system) and agricultural work machine (e.g., harvester) can be set based on the operation profile 334 for the performance (e.g., residue performance) characteristics and based on the other inputs 350, such as crop condition 320 and field conditions 318. That is, for example, in the case of a harvester with a residue system, the speed of the residue rotor, speed of the residue spreader, position of a residue spreader (or spreader vane or spreader shroud), and/or setting of the knifebank operational position (as described above) can be initially set for the residue system, along with the harvester speed, and other harvester conditions, all based on the input desired operation profile (e.g., input desired residue performance characteristics). In this way, at the initiation of operation, the agricultural work machine (e.g., harvester) and system(s) (e.g., residue system) can operate under these parameters of the operation profile 334 to meet the desired operation profile 334. Further, ranges indicated by the profile 334 can be preset for each of the input data 350 (e.g., power consumption 310, residue performance 312, etc.) that are expected to meet the operation profile 334 during operation.

During operation, the control unit 302 can monitor the input data 350 (e.g., or a monitoring portion of the control unit 302) to identify if the data inputs 350 are within the operational ranges (e.g., the threshold conditions) of the operation profile 334. As an example, if the input data 350 identifies that the ranges of the operation profile 334 are being met, the operation of the agricultural work machine (e.g., harvester) can maintain operational parameters. When data inputs 350 indicate that agricultural operation (e.g., harvesting) performance parameters are outside the thresholds of the operation profile 334, the control unit 302 can generate action commands 352 that adjust one or more portions of the agricultural work machine (e.g., harvester 360) operation (e.g., the operational parameters of the harvester) to bring the performance parameters within the threshold ranges.

As another example, some of the data input 350 (e.g., crop conditions 320 and field conditions 318) may indicate that adjustments may need to be made to the operational thresholds. That is, for example, if a lower (e.g., or higher) crop density is predicted for an upcoming location, the thresholds may need to be adjusted (e.g., by way of a responsiveness evaluation) to accommodate the expected change in conditions such that performance, such as residue performance (e.g., chopping quality, residue spread quality, etc.) and/or power consumption can meet desired levels. That is, for example, a higher density or bulk flow of crop into the harvester may result in higher power consumption to accommodate the chopping or spreading of the extra material. In order to accommodate the change in power consumption to meet a desired power use range, the system described herein can make a slight adjustment (e.g., operational parameter adjustment) to the residue system (e.g., adjustment to the knifebank, adjustment to the spreader, etc.) to reduce the power consumption, while only having a minimal effect on the residue performance (e.g., chopping quality, residue spread quality, etc.). In this example, the threshold range can be adjusted to account for this condition. The threshold range may be adjusted to account for a change in power consumption and residue performance (e.g., chopping quality, residue spread quality, etc.).

Further, in this example, feedback data 340 can be provided when changes (e.g., changes to operational parameters) are made to the system (e.g., residue system 362) and/or other components in the agricultural work machine (e.g., harvester 360). This data can be provided to the control unit 302, which could identify how/if the adjustments (e.g., operational parameter adjustments) affected the performance parameters. In some implementations, the feedback data 340 can provide a feedback loop that the control unit 302 can use to train (e.g., adjust in real-time) the decisions on when and what to adjust during operation. Additionally, a trained model may be developed and used for future agricultural operations (e.g., harvesting operations) in similar situations, and/or as historical agricultural operation (e.g., historical harvesting) data for the location and crop type, given the conditions.

As another example, when the input data 350 indicates a high degree of variability between the input data 350 over time (e.g., at pre-selected intervals, or continuously), the control unit 302 may adjust sensitivity of the adjustments. As described above, some adjustments to the residue system can have disproportional effects on the power consumption. In these situations (e.g., situations of high variability of the input data 350, such as high variability of site conditions), it may be undesirable to make multiple adjustments over a short period of time, as this can have adverse effects on power consumption and residue performance (e.g., chopping quality, residue spread quality, etc.). The operational parameters of the harvester 360 and residue systems 362 can be adjusted to meet the preferred operation profile 334, but it may be undesirable to adjust the parameters too quickly or to over-adjust (e.g., when conditions at the field are highly variable), which may lead to undesired results. As such, a predetermined threshold of variability (e.g., indicative of sensitivity) can be set, and if met (e.g., above threshold of variations), then the control unit 302 can use the instructions 336 to adjust a response sensitivity of the residue system (e.g., reduced) so that the system is not overly responsive in adjustment of operational parameters. That is, for example, if the threshold sensitivity is too sensitive for the harvesting operational conditions, such as site conditions (e.g., field, crop, weather, etc.), then the response sensitivity can be adjusted to be less sensitive. Additionally, based on the input data 350, an operational efficiency of the residue system can be improved by adjusting maximum performance limits on the fly, to avoid adverse conditions (e.g., over power consumption, with poor residue performance, such as poor chopping quality and/or poor residue spread quality). Alternately, if the variability level is determined to be low (e.g., little change in conditions provided by the input data 350) then response sensitivity of the residue system 362 can be modified (e.g., increased) so that the system is more responsive to detected changes. In these implementations, the sensitivity level can be continually (or periodically) monitored and adjusted to meet operational conditions.

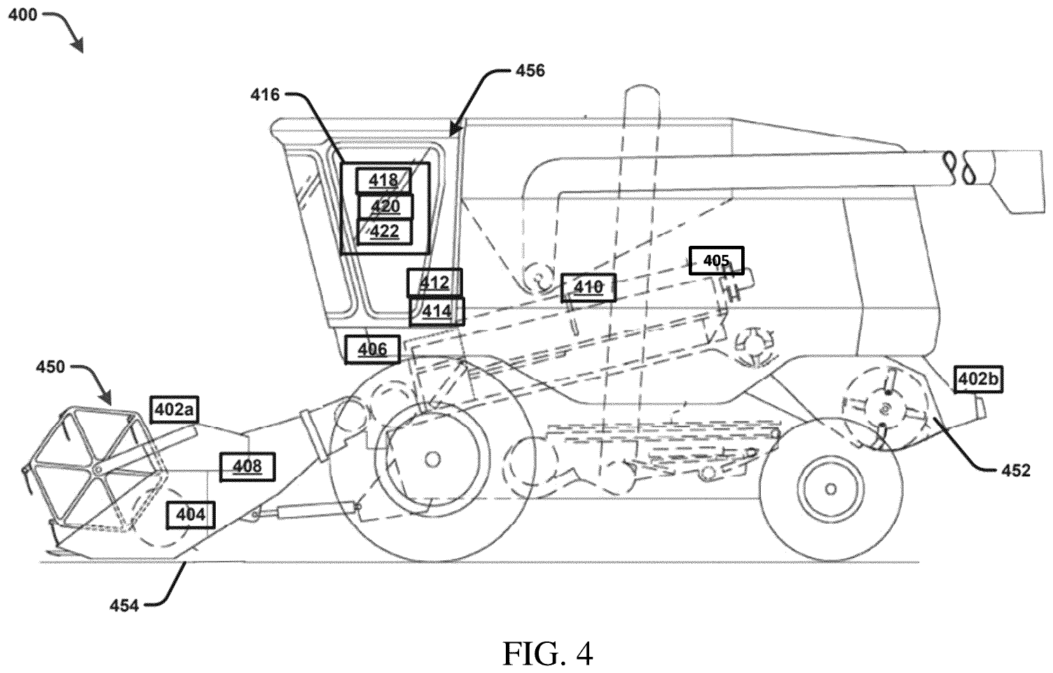

FIG. 4 is a component diagram illustrating one example implementation of an agricultural work machine system (or agricultural work machine), a harvester system 400 (or harvester 400) as implemented herein. In one or more examples, an imaging component 402a (e.g., camera) captures images of the crop intake at the header 450, a pressure sensor 404 is disposed in the header to detect a bulk flow rate through the header 450, and/or a pressure sensor 405 associated with the threshing element to detect a bulk flow rate through the harvester. Further, an imaging component 402b can be disposed at the residue system 452 to detect a condition of the residue generated by the harvester 400 (e.g., a performance parameter). In one implementation, the image sensors 402a, 402b can capture images of the crop before and after the crop has been discharged from the harvester; and can capture images of the residue to check for residue performance (e.g., residue chopping quality, residue spread quality, etc.). In some implementations, multiple image sensors 402 are utilized at each location to capture images of the crop and crop residue before, during and after collection and processing of the crop. The image data can be used as the input data 350. The image data can be compared with data that is indicative of the desired operation profile to determine if the performance, such as residue performance (e.g., chopping quality, residue spread quality, etc.) is being met, or if adjustments need to be made.

Alternately, a pressure sensor 404 in the header 450 can detect an amount of pressure needed to collect the crop. This pressure data can be indicative of the bulk flow of the crop through the header 450, and used as the input data 350. Alternatively, a pressure sensor 405 associated with the threshing element can detect a pressure used to drive the threshing element to thresh the harvested material and this pressure can indicative of bulk flow of the crop through the harvester

Further, as described above, a speed sensor 406 can be disposed in the harvester 400 to detect ground speed. A height sensor 408 can be used to detect a height of the header 450 above the ground 454. A grain sensor 410 may be used to detect the condition of grain harvested, amount of grain, and potential grain loss (e.g., when compared with bulk flow). Further, a weather sensor 412 and a terrain sensor 414 can be disposed on the harvester to detect weather conditions and to detect terrain conditions, respectively, in real time. In some implementations, a computing device 416 can be disposed in the operator cab 456. In these implementations, the computing device 416 can comprise a UI 418 for user input, and may also comprise a mapping application 420 and a weather application 422. The mapping application 420 can provide various data, as previously described, such as terrain data, and the weather application 422 can provide weather data.

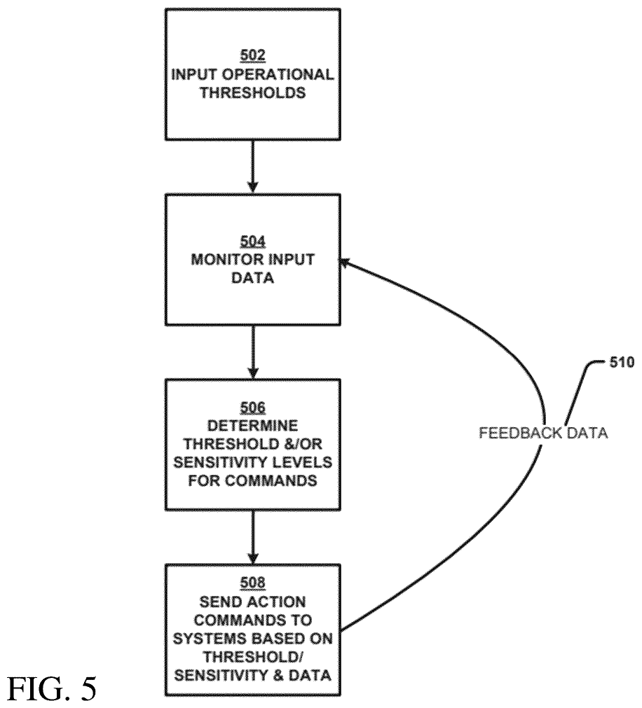

FIG. 5 is a flow diagram illustrating an example method for adjusting the sensitivity of an agricultural work machine system (e.g., harvester residue system) to meet a desired performance (e.g., residue performance, such as residue chopping quality or residue spread quality), such as a desired performance of an operation profile. At 502, operational thresholds are input by the operator or a pre-programmed system. The operational thresholds can be set by an input of the operation profile for the desired performance, such as residue performance (e.g., residue chopping quality, residue spread quality, etc.) and power efficiency utilization. That is, as described above, the operation profile can be representative of an initial operation profile that can include target operational parameters and desired outcome of the performance, such as residue performance (e.g., chopping quality, residue spread quality, etc.), based on various operating conditions, such as known crop conditions, type and specification of agricultural work machine (e.g., harvester), field conditions. In this way, the operation profile can provide for a pre-determined setting (e.g., operational parameter) for the system (e.g., residue system) that provides for the desired performance.

At 504, the various data inputs are monitored by one or more sensors (e.g., a sensor array) disposed in/on the agricultural work machine (e.g., harvester) and/or system (e.g., residue system); and/or inputs from programs, such as mapping and weather applications, as well as prediction models. The inputs, as described above, can comprise a variety of real-time data, such as bulk flow rate of intake crop, density and quality of outgoing residue, the speed of the harvester, the power consumption, the weather conditions, and terrain conditions, and more. As described above, predictions for certain crop and field conditions, which may affect other data points, can be made based on locations in the field, predicted weather, predicted crop conditions. These predictions can be made periodically (e.g., at desired time intervals) and/or continuously.

At 506, a control unit receives the input data and processes the input data in accordance with pre-programmed instructions to determine updated (if needed) thresholds for making adjustment, and/or to adjust a level of sensitivity for potential adjustment commands. The input data is indicative of the real-time conditions and predictive conditions of the agricultural operation (e.g., harvesting operation), agricultural work machine (e.g., harvester), and system (e.g., residue system), and identifies the variability of the inputs (e.g., changes in conditions over time). Based on the variability of the data, the threshold levels can be adjusted, and a level of adjustment sensitivity can be adjusted. That is, if a condition is expected to change or is changing, the system (e.g., residue system) threshold for making an adjustment to the system (e.g., residue system) can be updated to account for the changes. If the level or number of changes (variability) occurs frequently over time (e.g., based on preset thresholds), the level of sensitivity can be adjusted (e.g., lowered) so that the action commands for the system (e.g., residue system) are not over adjusting the system (e.g., making rapid adjustments). Alternately, if the level or number of changes (variability) is low over time, the level of sensitivity can be increased to account for fewer and smaller changes over time.

At 508, the action commands are generated and sent to the agricultural work machine (e.g., harvester) and system (e.g., residue system) to make appropriate adjustments to the operational parameters based on the level of sensitivity and the input data. That is, for example, adjustment to the system (e.g., residue system) operational parameters (e.g., knifebank adjustments, rotation speed, etc.) can be made to adjust performance. In this way, the desired performance (e.g., of operation profile) can be maintained at the desired level during operation, including performance, such as residue performance (e.g., chopping quality, residue spread quality, etc.) and power consumption, regardless of how quickly or slowly the sensed input data changes.

Feedback data 510 that is indicative of performance parameters after the system adjustments have been made can be used for the monitoring of the input data. That is, for example, the action commands can make adjustments to portions of the system (e.g., residue system), which can alter performance, such as residue performance (e.g., chopping quality, spread quality, etc.), and power consumption, among other things. The feedback data 510 can comprise sensor data that is a result of the changes made to the system. In this implementation, the feedback data 510 can be used to continually update and train a predictive model resident in the control unit (e.g., in memory) to refine and learn how certain changes to the system, in certain conditions, provide for certain results. In this way, the predictive model can make more informed decisions on system changes based on the known conditions and results learned from the feedback data 510.

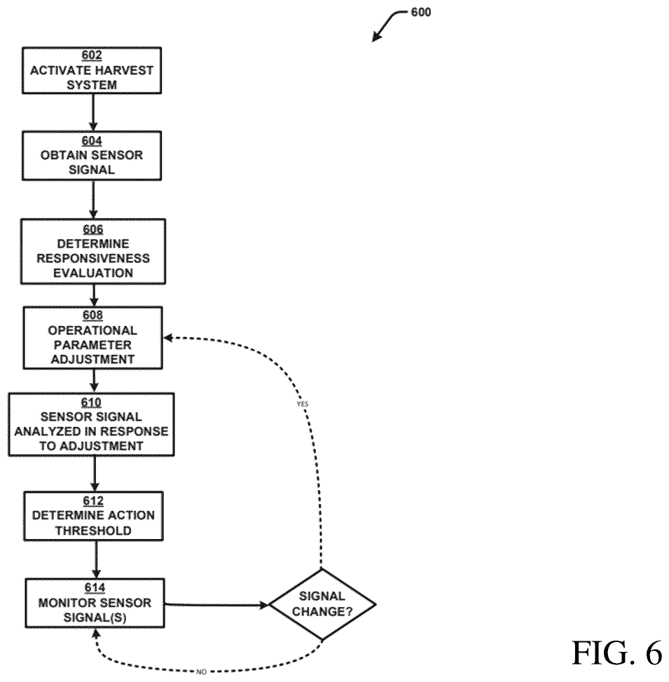

Another implementation of a method to improve the controlling of various systems of an agricultural work machine (e.g., harvester), as described above, such as a residue system in a harvester, may be devised. For example, the method can be used to determine a response sensitivity of adjustments made to the control system operations of the agricultural work machine (e.g., harvester) during an agricultural operation (e.g., harvesting operation). FIG. 6 is a flow diagram illustrating one such example method 600.

At 602 an agricultural system (e.g., harvest system) can be activated, such as by starting the agricultural operation (e.g., harvest operation) and starting the control system (e.g., 302 of FIG. 3). At 604, a sensor signal is obtained for a characteristic of interest, such as a characteristic of the agricultural work machine (e.g., harvester) operation (e.g., operational parameter), or a characteristic of operation performance (performance parameter). For example, data derived from the signal can represent an absolute value, such as 2% of sensed grain loss, which equals 2% of actual loss. Alternately, data derived from the signal can represent a relative value. For example, a 5% change in chopping quality may not represent an actual change of 5% as recorded on the ground, but is a larger change in the chopping quality data than a 2% change. In this example, the data from the signal may also represent a proportional or differential change (e.g., 2.5× change or 3% change).

At 606, a determination of a responsiveness evaluation is performed. That is, as described above, the control system can determine whether the responsiveness (e.g., sensitivity) to commands or adjustments should be evaluated and changed, such as based on responsiveness evaluation criteria. In some implementations, the determination of performing an evaluation can be based on, as a responsiveness evaluation criterion, when a threshold value used by the system does not elicit the desired response, such as to performance parameters or agricultural work machine (e.g., harvester) operational parameter control. In some implementations, the determination of performing an evaluation can be based on, as a responsiveness evaluation criterion, a time interval, such as the time from the last evaluation. In some implementations, the determination of performing an evaluation can be based on, as a responsiveness evaluation criterion a field characteristic for the operation, for example, where a location in the field is identified based on terrain (e.g., rolling, flat, steep, variable), crop condition (e.g., consistency/variability—could be historical variability (i.e. previous years yield map) or a measured variability (e.g., current NDVI map) or a predicted variability indicated by a predictive map (e.g., predicted yield).

At 608, at least one operational parameter (e.g., harvester system setting) can be adjusted. For example, the adjustment may be large or small, or could be a multiple or combination of each. At 610, a subsequent sensor signal(s) is received, and the subsequent sensor signal(s) is analyzed in response to the operational parameter adjustment, to identify the changes in the data from the signal (e.g., to identify changes in the performance parameter in response to the operational parameter adjustment). For example, the analysis can be performed using absolute performance values or relative performance values, as described above in 604.

At 612, the controller (e.g., instructions processed by the controller) can determine an action threshold level based on the sensor signal changes and the operational parameter adjustments. For example, the changes to the data (e.g., performance parameter data) provided by the sensor signal resulting from the adjustments made to the operational parameters, can be used to determine a (e.g., new) action threshold. That is, the amount of change in the signal (e.g., sensed performance parameter) that was associated with the operational parameter adjustment becomes an action threshold level (e.g., new threshold, if changed). For example, the system is identifying what change the system may actually be able to respond to and make a meaningful correction to performance parameters. In this way, in some implementations, the system is learning the capability of the system to respond and influence an outcome, such as by analyzing the resulting performance from operational parameter adjustments, based on the operational situation.

For example, there are several ways, amongst others, that this may be implemented. In one implementation, the change in the sensor signal (e.g., sensed performance parameter) can be directly compared with the total operational adjustment to derive the action threshold. In one implementation, the change in the sensor signal (e.g., sensed performance parameter) can be scaled for the step size of the set operational parameter adjustment, to derive the action threshold. In some implementations, the step size of the operational parameter adjustment can be based on a desired sensor signal change threshold.

At 614, in the example method 600, the controller can monitor the sensor signals and determine when the signal has changed (e.g., from a target level or from a previous level) by the action threshold level, at 616. If the signal has changed, the controller can make the adjustment to the operational parameter by the adjustment amount previously associated with the action threshold, at 608. If the signal has not changed, the system continues to monitor the sensor signals, at 614.

Following are some example implementations of the systems and methods described herein. While the following examples are described with respect to a residue performance (e.g., residue chopping quality, residue spread quality, etc.), other characteristics of interest, including various other agricultural work machine (e.g., harvester) system operations, can also be used. In these examples, the starting system can comprise a factory or preset action threshold for a system operation, such as residue performance (e.g., chopping quality, residue spread quality, etc.), for example, can be set to 10% (e.g., range of residue performance, such as chopping quality or spread quality, deviation). Further, in these example, a factory or preset target value for system operation, such as residue performance (e.g., chopping quality, spread quality, etc.), for example, can be set to 50%. Additionally, in these examples, a factory or preset operational parameter adjustment of a system operation, such as a knifebank position of the residue system, for example, can be set to 20 mm (e.g., having a range of 0 to 100 mm).

In a first example, a machine enters a field with generally dry straw. The system determines presence of a responsiveness evaluation criterion (e.g., that the time or location in the field is appropriate to perform a responsiveness evaluation). Thus, the machine performs a responsiveness evaluation. During the evaluation, the system reads a current chop quality sensor signal of 75%, and provides a command to make a knifebank adjustment of 20 mm (e.g., reducing knifebank engagement), expecting that the chop quality signal should reduce. In this example, the chop quality signal remains generally unchanged. Subsequently, the system provides a command to make a knifebank adjustment of an additional 20 mm (e.g., reducing knifebank engagement). A subsequent sensor signal indicates that the chop quality signal changes to 70%.

Due to the change in the sensor signal (e.g., from 75% to 70%), the system establishes a (e.g., new) action threshold. In this example, the action threshold can be established in one of several ways. The action threshold of the signal can be set to 5% (e.g., difference between the first and second signal values), and the operational adjustment can be set to 40 mm (e.g., amount of adjustment made—two adjustments of 20 mm as described above). Alternately, the action threshold of the signal value can be set to 2.5%, and operational adjustment remains at 20 mm. This represents a proportional or step approach, maintaining the ratio or relationship between the signal value and operational parameter adjustment value. Alternately, the action threshold can remain at 10%, and the operational step size can be set to 80 mm. This approach provides for a proportional, step approach that provides for the same results.

In a second example, using similar type of steps described above, the harvester enters the field with a normal-type straw. In this example, the system determines presence of a responsiveness evaluation criterion (e.g., that the time or location is appropriate to perform a responsiveness evaluation). The machine performs a responsiveness evaluation. In this example, the system identifies (e.g., through sensor signal) that there is a current chop quality of 40%. The system generates a command to make a knifebank adjustment of 20 mm (e.g., increasing knifebank engagement), expecting that the chop quality signal should increase. In this example, the data from the signal indicates a chop quality change to 80%. The system then establishes an action threshold. Again, this determination of the action threshold can be made in several ways. In this example, the action threshold of value for signal is set to 40%, and the operational parameter adjustment set to 20 mm. Alternately, the action threshold of value for signal is set to 40%, and the operational parameter adjustment remains at 20 mm. Alternately, the action threshold of value for signal remains at 10%, and the operational parameter adjustment changes to 5 mm.

These examples are illustrative of one or more methods for generating the action threshold value, as described herein, which, in turn, helps control the sensitivity of the control of the system.

FIG. 7 is a block diagram showing another example of system 300. System 300 includes an agricultural work machine (e.g., harvester) 360. System 300 also includes one or more remote computing systems 3000, one or more networks 3059, one or more remote user interface mechanisms 3064, and can include a variety of other items 2002 as well. As shown in FIG. 7, harvester 360, itself, illustratively includes one or more

processors or servers 4002, one or more data stores 4004, one or more communication systems 4006, one or more sensors 4008, control unit 302, map application 328, weather application 330, one or more controllable subsystems 4016, one or more operator interface mechanisms 4018, and can include various other items and functionality 4019 as well.

Remote computing systems 3000, as illustrated, include one or more processors or servers 3002, one or more data stores 3004, one or more communication systems 3006, and can include various other items and functionality 3019.

Data stores 3004 and data stores 4004 each store a variety of data (generally indicated data 3005 and data 4005 respectively), such as the various data described herein (e.g., site condition data 316, sensor data, feedback 340, profile/parameters 334, etc.). Additionally, data 3005 can include computer executable (readable) instructions that are executable by one or more processors or servers 3002 to implement other items or functionalities of system 300, including other items of remote computing systems 3000. Additionally, data 4005 can include computer executable (readable) instructions that are executable by one or more processors or servers 4002 to implement other items or functionalities of system 300, including other items or functionalities of harvester 306. The computer executable instructions in data stores 3004 and data stores 4004 can include instructions 336. It will be understood that data stores 3004 and data stores 4004 can include different forms of data stores, for instance both volatile data stores (e.g., Random Access Memory (RAM)) and non-volatile data stores (e.g., Read Only Memory (ROM), hard drives, solid state drives, etc.). Further, it will be understood that data stores 3004 and data stores 4004 can include memory 304 or can include memory that stores information similar to the information stored in memory 304 as previously described and obtainable for use by other items of system 300 as previously described.

Processor(s) or servers 3002 and processor(s) or servers 4002 can include processor 306 or can include processors similar to processor 306 and can be used to enable functionality similar to the functionality of processor 302 as previously described.

Sensors 4008 can include operation sensors 308 and can include various other sensors 4028 as well. The sensor data (e.g., images, signals, etc.) generated by sensors 4008 can be communicated to remote computing systems 3000, and to other items of harvester 360.

Control unit 110 has been previously described herein and can, among other things (as previously described), generate control signals (e.g., action commands 352) to control one or more components of system 300, such as one or more components of harvester 360, such as controllable subsystems 4016 (e.g., to adjust operational parameters of the controllable subsystems 4016), interface mechanisms 4018, and communication system 4006.

Map application 328 and weather application 330 have been previously described herein.

As shown, controllable subsystems 4016 include one or more actuators 4050 as well as various other items 4056. Actuators 450 include a variety of different types of actuators. Actuators 4050 can include actuators that control the position (e.g., height, depth, or spacing) or orientation (e.g., pitch, roll, yaw, etc.) of components of harvester 360 as well as actuators that control a speed of movement (e.g., speed of rotation, speed of reciprocation, etc.) of components of harvester 360. Actuators 4050 can include, without limitation, motors, valves, pumps, hydraulic actuators (e.g., hydraulic cylinders, etc.), pneumatic actuators (e.g., pneumatic cylinders, etc.), electric actuators (e.g., linear actuators, etc.), as well as various other types of actuators. Some examples of actuators 4050 have been previously shown and described herein, such as actuators described in FIGS. 1 and 2 as well as other actuators described herein. Actuators 4050 are controllable to adjust operational parameters of various components of an agricultural work machine, such as harvester 360, such as the various operational parameters described elsewhere herein.

Communication systems 4006 are used to communicate between components of harvester 360, or with other items of system 300, such as remote computing systems 3000 or user interface mechanisms 3064, or a combination thereof. Communication systems 3006 are used to communicate between components of a remote computing system 3000 or with other items of system 300, such as harvester 360, other remote computing systems 3000, or user interface mechanisms 3064, or a combination thereof.

Communication systems 3006 and 4006 can both include one or more of wired communication circuitry and wireless communication circuitry, as well as wired and wireless communication components. In some examples, communication systems 3006 and 4006 can include one or more of a system for communicating over various networks, such as a communication system for communicating over the Internet, a cellular communication system, a system for communicating over a wide area network or a local area network, a system for communicating over a controller area network (CAN), such as a CAN bus, a system for communicating over a controller area network flexible data-rate (CAN-FD), such as a CAN-FD bus, a system for communication over a near field communication network, a system for communicating over ethernet, or a communication system configured to communicate over any of a variety of other networks. Communication systems 3006 and 4006 can both also include a system that facilitates downloads or transfers of information to and from a secure digital (SD) card or a universal serial bus (USB) card, or both. Communication systems 3006 and 4006 can both utilize network 3059. Networks 3059 can be any of a wide variety of different types of networks such as the Internet, a cellular network, a wide area network (WAN), a local area network (LAN), a controller area network (CAN), a controller area network flexible data-rate (CAN-FD), a near-field communication network, ethernet, or any of a wide variety of other networks.

FIG. 7 shows that one or more operators 3061 can operate harvester 360. Operators 361 interact with operator interface mechanisms, such as operator interface mechanism 4018. In some examples, operator interface mechanisms 4018 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, operators 3061 can interact with operator interface mechanisms 4018 using touch gestures. Additionally, at least some of the operator interface mechanisms 4018 can be used to present (e.g., display, audible presentation, haptic presentation, etc.) various information. One example of an operator interface mechanism 4018 is UI 332. The examples described above are provided as illustrative examples and are not intended to limit the scope of the present disclosure. Consequently, other types of operator interface mechanisms 4018 can be used and are within the scope of the present disclosure.

Additionally, in some examples, some operator interface mechanisms 4018 can be separate from (or separable from), but communicatively coupled to harvester 360.

FIG. 7 also shows remote users 3066 interacting with harvester 360, and remote computing systems 3000 through user interface mechanisms 3064 over networks 3059. In some examples, user interface mechanisms 3064 can include joysticks, levers, a steering wheel, linkages, pedals, buttons, wireless devices (e.g., mobile computing devices, etc.), dials, keypads, a display device (including a display screen), user actuatable elements (such as icons, buttons, etc.) on a display device, a microphone and speaker (where speech recognition and speech synthesis are provided), among a wide variety of other types of control devices. Where a touch sensitive display system is provided, the users 3066 can interact with user interface mechanisms 3064 using touch gestures. Additionally, at least some of the user interface mechanisms 3064 can be used to present (e.g., display, audible presentation, haptic presentation, etc.) various information. One example of a user interface mechanism 3064 is UI 332. The examples described above are provided as illustrative examples and are not intended to limit the scope of the present disclosure.

Consequently, other types of user interface mechanisms 3064 can be used and are within the scope of the present disclosure.

Remote computing systems 3000 can be a wide variety of different types of systems, or combinations thereof. For example, remote computing systems 3000 can be in a remote server environment. Further, remote computing systems 3000 can be remote computing systems, such as mobile devices, a remote network, a farm manager system, a vendor system, or a wide variety of other remote systems. In one example, harvester 360 can be controlled remotely by remote computing systems 3000 or by remote users 3066, or both. In some examples, operators 3061 are on-board (e.g., in an operator compartment, such as a cab) of harvester 360. In some examples, operators 3061 are remote from the harvester 360 and control the harvester 360 through one or more interface mechanisms (e.g., 4018) which are remote from the machine but operatively coupled (e.g., communicatively coupled, such as over networks 3059) to the machine (e.g., 360).

As previously described, items in system 300 can be distributed in various ways. For example, items in system 300 can be distributed in various ways, including ways that differ from the example shown in FIG. 7. For example, but not by limitation, control unit 302, shown in FIG. 7 as being disposed on harvester 360, can be located elsewhere, such as at one or more remote computing systems 3000. In yet other examples, control unit 302 can be distributed across multiple items of system 300, including for example, across a harvester 360 and a remote computing system 3000. In yet other examples, each of the harvester 360 and a remote computing system 3000 can include a respective control unit 302. Further, other items of system 300, such as map application 328 and weather application 330, can be distributed in various ways, including in ways similar to the ways in which control unit 302 can be distributed.

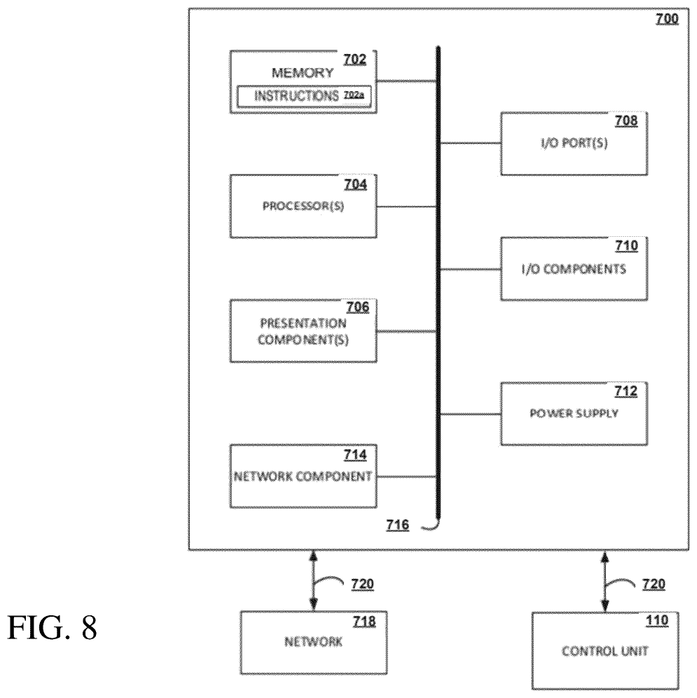

FIG. 8 is a schematic block diagram illustrating a block diagram of a computing device 700 suitable for implementing various aspects of the disclosure as described. For example, in operation, the computing device 700 is operable with the control unit 110 to control operation of a system of an agricultural work machine such as a residue system of a harvester as describe in more detail herein. FIG. 8 and the following discussion provide a brief, general description of a computing environment in/on which one or more or the implementations of one or more of the methods and/or system set forth herein may be implemented. The operating environment of FIG. is merely an example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, mobile consoles, tablets, media players, and the like), multiprocessor systems, consumer electronics, mini computers, mainframe computers, distributed computing environments that include any of the above systems or devices, and the like.

Although not required, implementations are described in the general context of “computer readable instructions” executed by one or more computing devices. Computer readable instructions may be distributed via computer readable media (discussed below). Computer readable instructions may be implemented as program modules, such as functions, objects, Application Programming Interfaces (APIs), data structures, and the like, which perform particular tasks or implement particular abstract data types Typically, the functionality of the computer readable instructions may be combined or distributed as desired in various environments.

In some examples, the computing device 700 includes a memory 702, one or more processors 704, and one or more presentation components 706. The disclosed examples associated with the computing device 700 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 8 and the references herein to a “computing device.” The disclosed examples are also practiced in distributed computing environments, where tasks are performed by remote-processing devices that are linked through a communications network. Further, while the computing device 700 is depicted as a single device, in one example, multiple computing devices work together and share the depicted device resources. For instance, in one example, the memory 702 is distributed across multiple devices, the processor(s) 704 provided are housed on different devices, and so on.

In one example, the memory 702 includes any of the computer-readable media discussed herein. In one example, the memory 702 is used to store and access instructions 702a configured to carry out the various operations disclosed herein. In some examples, the memory 702 includes computer storage media in the form of volatile and/or nonvolatile memory, removable or non-removable memory, data disks in virtual environments, or a combination thereof. In one example, the processor(s) 704 includes any quantity of processing units that read data from various entities, such as the memory 702 or input/output (I/O) components 710. Specifically, the processor(s) 704 are programmed to execute computer-executable instructions for implementing aspects of the disclosure. In one example, the instructions 702a are performed by the processor 704, by multiple processors within the computing device 700, or by a processor external to the computing device 700. In some examples, the processor(s) 704 are programmed to execute instructions such as those illustrated in the flow charts discussed herein and depicted in the accompanying drawings.

In other implementations, the computing device 700 may include additional features and/or functionality. For example, the computing device 700 may also include additional storage (e.g., removable and/or non-removable) including, but not limited to, magnetic storage, optical storage, and the like. Such additional storage is illustrated in FIG. 8 by the memory 702. In one implementation, computer readable instructions to implement one or more implementations provided herein may be in the memory 702 as described herein. The memory 702 may also store other computer readable instructions to implement an operating system, an application program and the like. Computer readable instructions may be loaded in the memory 702 for execution by the processor(s) 704, for example.

The presentation component(s) 706 present data indications to an operator or to another device. In one example, the presentation components 706 include a display device, speaker, printing component, vibrating component, etc. One skilled in the art will understand and appreciate that computer data is presented in a number of ways, such as visually in a graphical user interface (GUI), audibly through speakers, wirelessly between the computing device 700, across a wired connection, or in other ways. In one example, the presentation component(s) 706 are not used when processes and operations are sufficiently automated that a need for human interaction is lessened or not needed. I/O ports 708 allow the computing device 700 to be logically coupled to other devices including the I/O components 710, some of which is built in. Implementations of the I/O components 710 include, for example but without limitation, a microphone, keyboard, mouse, joystick, pen, game pad, satellite dish, scanner, printer, wireless device, camera, etc.

The computing device 700 includes a bus 716 that directly or indirectly couples the following devices: the memory 702, the one or more processors 704, the one or more presentation components 706, the input/output (I/O) ports 708, the I/O components 710, a power supply 712, and a network component 714. The computing device 700 should not be interpreted as having any dependency or requirement related to any single component or combination of components illustrated therein. The bus 716 represents one or more busses (such as an address bus, data bus, or a combination thereof). Although the various blocks of FIG. 8 are shown with lines for the sake of clarity, some implementations blur functionality over various different components described herein.

The components of the computing device 700 may be connected by various interconnects. Such interconnects may include a Peripheral Component Interconnect (PCI), such as PCI Express, a Universal Serial Bus (USB), firewire (IEEE 1394), an optical bus structure, and the like. In another implementation, components of the computing device 700 may be interconnected by a network. For example, the memory 702 may be comprised of multiple physical memory units located in different physical locations interconnected by a network.

In some examples, the computing device 700 is communicatively coupled to a network 718 using the network component 714. In some examples, the network component 714 includes a network interface card and/or computer-executable instructions (e.g., a driver) for operating the network interface card. In one example, communication between the computing device 700 and other devices occurs using any protocol or mechanism over a wired or wireless connection 720. In some examples, the network component 714 is operable to communicate data over public, private, or hybrid (public and private) connections using a transfer protocol, between devices wirelessly using short range communication technologies (e.g., near-field communication (NFC), Bluetooth® branded communications, or the like), or a combination thereof.

The connection 720 may include, but is not limited to, a modem, a Network Interface Card (NIC), an integrated network interface, a radio frequency transmitter/receiver, an infrared port, a USB connection or other interfaces for connecting the computing device 700 to other computing devices. The connection 720 may transmit and/or receive communication media.

Although described in connection with the computing device 700, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, VR devices, holographic device, and the like. Such systems or devices accept input from the user in any way, including from input devices such as a keyboard or pointing device, via gesture input, proximity input (such as by hovering), and/or via voice input.

Implementations of the disclosure, such as controllers or monitors, are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprises computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms can include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition can be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores can be local to the systems accessing the data stores, one or more of the data stores can all be located remote form a system utilizing the data store, or one or more data stores can be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality can be distributed among more components. In different examples, some functionality can be added, and some can be removed.

It will be noted that the above discussion has described a variety of different systems, units, applications, components, and interactions. It will be appreciated that any or all of such systems, units, applications, components, and interactions can be implemented by hardware items, such as one or more processors, one or more processors executing computer executable instructions stored in memory, memory, or other processing components, some of which are described elsewhere herein, that perform the functions associated with those systems, units, applications, components, and interactions. In addition, any or all of the systems, units, applications, components, and interactions can be implemented by software that is loaded into a memory and is subsequently executed by one or more processors or one or more servers or other computing component(s), as described elsewhere herein. Any or all of the systems, units, applications, components, and interactions can also be implemented by different combinations of hardware, software, firmware, etc., some examples of which are described elsewhere herein. These are some examples of different structures that can be used to implement any or all of the systems, units, applications, components, and interactions described above. Other structures can be used as well.

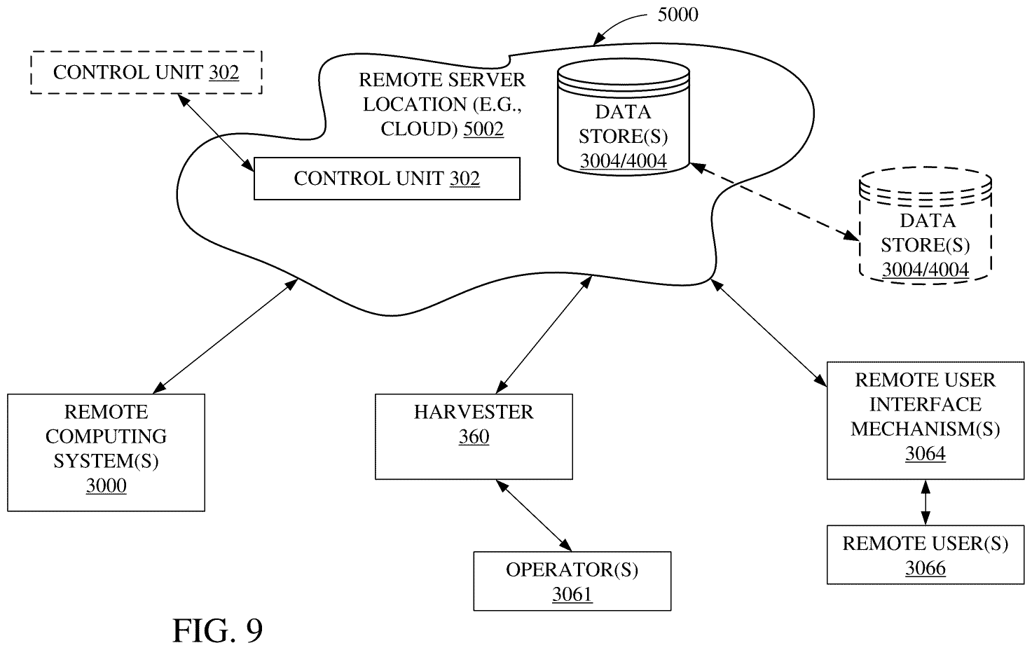

FIG. 9 is a block diagram of a remote server architecture 5000. FIG. 9, also shows harvester 360, one or more remote computing systems 300, and one or more remote user interface mechanisms 3064 in communication with the remote server environment. The harvester 360, remote computing systems 3000,, and remote user interface mechanisms 3064 communicate with elements in a remote server architecture 5000. In some examples, remote server architecture 5000 provides computation, software, data access, and storage services that do not require end-user knowledge of the physical location or configuration of the system that delivers the services. In various examples, remote servers can deliver the services over a wide area network, such as the internet, using appropriate protocols. For instance, remote servers can deliver applications over a wide area network and can be accessible through a web browser or any other computing component. Software or components shown in previous figures as well as data associated therewith, can be stored on servers at a remote location. The computing resources in a remote server environment can be consolidated at a remote data center location, or the computing resources can be dispersed to a plurality of remote data centers. Remote server infrastructures can deliver services through shared data centers, even though the services appear as a single point of access for the user. Thus, the components and functions described herein can be provided from a remote server at a remote location using a remote server architecture. Alternatively, the components and functions can be provided from a server, or the components and functions can be installed on client devices directly, or in other ways.

In the example shown in FIG. 9, some items are similar to those shown in previous figures and those items are similarly numbered. FIG. 9 specifically shows that control unit 302, data stores 3004, or data stores 4004, or a combination thereof, can be located at a server location 5002 that is remote from the harvester 360, remote computing systems 3000, and remote user interface mechanisms 3064. Therefore, in the example shown in FIG. 9, harvester 360, remote computing systems 3000, and remote user interface mechanisms 3064 access systems through remote server location 5002. In other examples, various other items can also be located at server location 5002, such as various other items of system 300.

FIG. 9 also depicts another example of a remote server architecture. FIG. 9 shows that some elements of previous figures can be disposed at a remote server location 5002 while others can be located elsewhere. By way of example, one or more of data store(s) 3004 and 4004 can be disposed at a location separate from location 5002 and accessed via the remote server at location 5002. Similarly, control unit 302 can be disposed at a location separate from location 5002 and accessed via the remote server at location 5002. Regardless of where the elements are located, the elements can be accessed directly by harvester 360, remote computing systems 3000, and remote user interface mechanisms 3064 through a network such as a wide area network or a local area network; the elements can be hosted at a remote site by a service; or the elements can be provided as a service or accessed by a connection service that resides in a remote location. Also, data can be stored in any location, and the stored data can be accessed by, or forwarded to, operators, users, or systems. For instance, physical carriers can be used instead of, or in addition to, electromagnetic wave carriers. In some examples, where wireless telecommunication service coverage is poor or nonexistent, another machine, such as a fuel truck or other mobile machine or vehicle, can have an automated, semi-automated or manual information collection system. As a mobile machine (e.g., harvester 360) comes close to the machine containing the information collection system, such as a fuel truck prior to fueling, or other mobile machine or vehicle, the information collection system collects the information from the mobile machine (e.g., harvester 360) using any type of ad-hoc wireless connection. The collected information can then be forwarded to another network when the machine containing the received information reaches a location where wireless telecommunication service coverage or other wireless coverage is available. For instance, a fuel truck, can enter an area having wireless communication coverage when traveling to a location to fuel other machines or when at a main fuel storage location. Other mobile machines or vehicles can enter an area having wireless communication coverage when traveling to other locations or when at another location. All of these architectures are contemplated herein. Further, the information can be stored on a mobile machine (e.g., harvester 360) until the mobile machine enters an area having wireless communication coverage. The mobile machine (e.g., harvester 360), itself, can send the information to another network.

It will also be noted that the elements of previous figures, or portions thereof, can be disposed on a wide variety of different devices. One or more of those devices can include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 5000 can include cybersecurity measures. Without limitation, these measures can include encryption of data on storage devices, encryption of data sent between network nodes, authentication of people or processes accessing data, as well as the use of ledgers for recording metadata, data, data transfers, data accesses, and data transformations. In some examples, the ledgers can be distributed and immutable (e.g., implemented as blockchain).

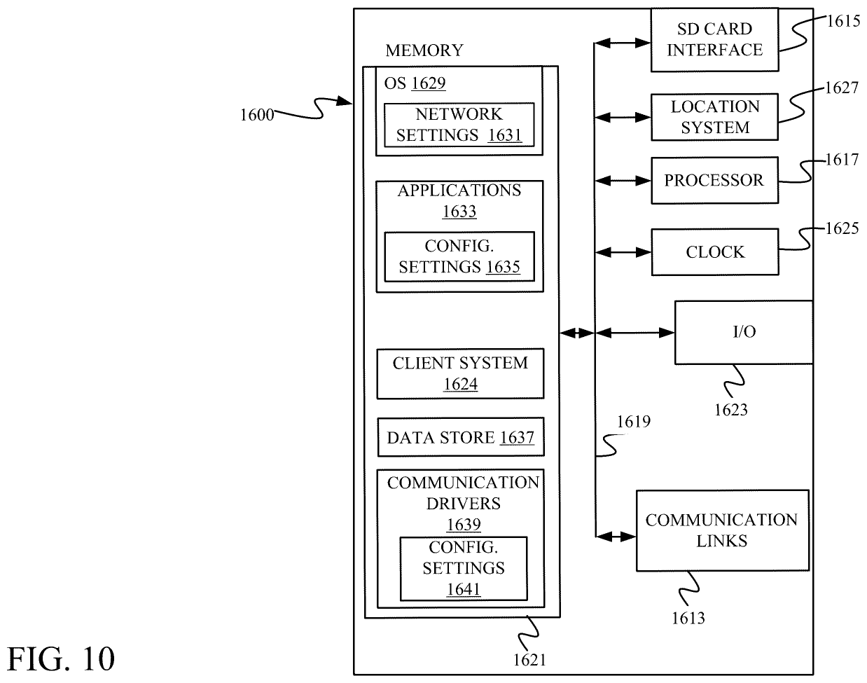

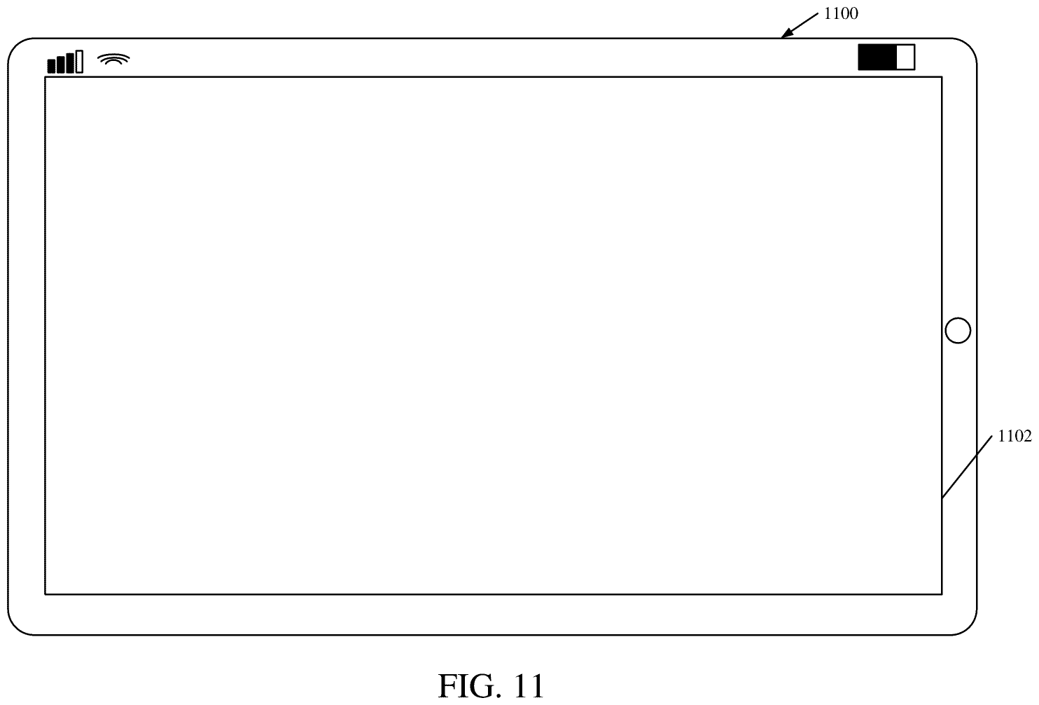

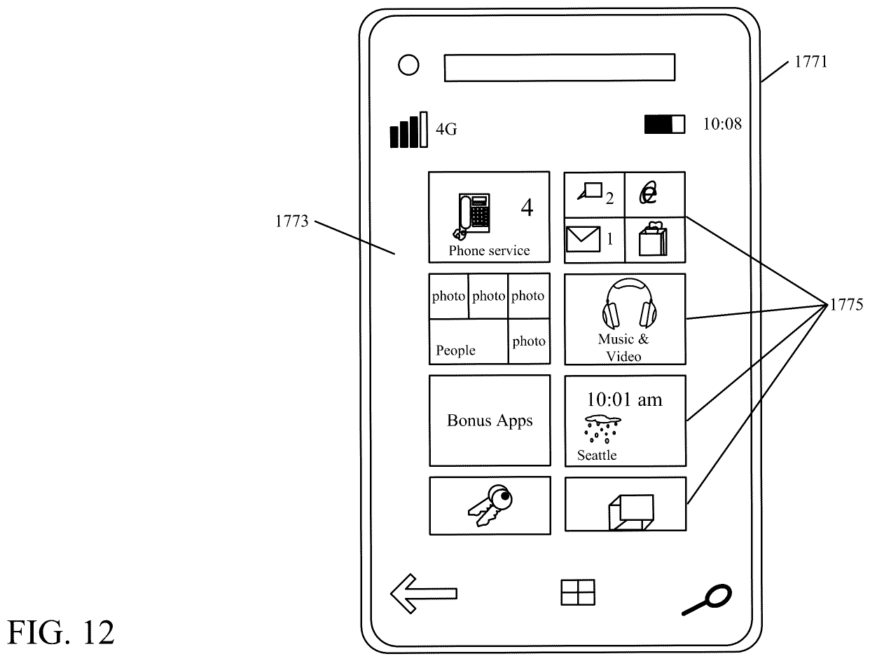

FIG. 10 is a simplified block diagram of one illustrative example of a handheld or mobile computing device that can be used as a user's or client's handheld device 1600, in which the present system (or parts of it) can be deployed. For instance, a mobile device can be deployed in the operator compartment of a mobile machine (e.g., harvester 360) or can be communicably coupled to a mobile machine (e.g., harvester 360) for use in generating, processing, or displaying the information and outputs discussed above. FIGS. 11 and 12 are examples of handheld or mobile devices.

FIG. 10 provides a general block diagram of the components of a client device 1600 that can run some components shown in previous figures, that interacts with them, or both. In the device 1600, a communications link 1613 is provided that allows the handheld device to communicate with other computing devices and under some examples provides a channel for receiving information automatically, such as by scanning. Examples of communications link 1613 include allowing communication though one or more communication protocols, such as wireless services used to provide cellular access to a network, as well as protocols that provide local wireless connections to networks.

In other examples, applications can be received on a removable Secure Digital (SD) card that is connected to an interface 1615. Interface 1615 and communication links 1613 communicate with a processor 1617 (which can also embody processors or servers from other figures) along a bus 1619 that is also connected to memory 1621 and input/output (I/O) components 1623, as well as clock 1625 and location system 1627.

I/O components 1623, in one example, are provided to facilitate input and output operations. I/O components 1623 for various examples of the device 1600 can include input components such as buttons, touch sensors, optical sensors, microphones, touch screens, proximity sensors, accelerometers, orientation sensors and output components such as a display device, a speaker, and or a printer port. Other I/O components 1623 can be used as well.

Clock 1625 illustratively comprises a real time clock component that outputs a time and date. It can also, illustratively, provide timing functions for processor 1617.

Location system 1627 illustratively includes a component that outputs a current geographical location of device 1600. This can include, for instance, a global positioning system (GPS) receiver, a LORAN system, a dead reckoning system, a cellular triangulation system, or other positioning system. Location system 1627 can also include, for example, mapping software or navigation software that generates desired maps, navigation routes and other geographic functions.

Memory 1621 stores operating system 1629, network settings 1631, applications 1633, application configuration settings 1635, client system 1624, data store 1637, communication drivers 1639, and communication configuration settings 1641. Memory 1621 can include all types of tangible volatile and non-volatile computer-readable memory devices. Memory 1621 can also include computer storage media (described below). Memory 1621 stores computer readable instructions that, when executed by processor 1617, cause the processor to perform computer-implemented steps or functions according to the instructions. Processor 1617 can be activated by other components to facilitate their functionality as well.

FIG. 11 shows one example in which device 1600 is a tablet computer 1100. In FIG. 11, computer 1100 is shown with user interface display screen 1102. Screen 1102 can be a touch screen or a pen-enabled interface that receives inputs from a pen or stylus. Tablet computer 1100 can also use an on-screen virtual keyboard. Of course, computer 1100 can also be attached to a keyboard or other user input device through a suitable attachment mechanism, such as a wireless link or USB port, for instance. Computer 1100 can also illustratively receive voice inputs as well.

FIG. 12 is similar to FIG. 11 except that the device is a smart phone 1771. Smart phone 1771 has a touch sensitive display 1773 that displays icons or tiles or other user input mechanisms 1775. Mechanisms 1775 can be used by a user to run applications, make calls, perform data transfer operations, etc. In general, smart phone 1771 is built on a mobile operating system and offers more advanced computing capability and connectivity than a feature phone.

Note that other forms of the devices 1600 are possible.

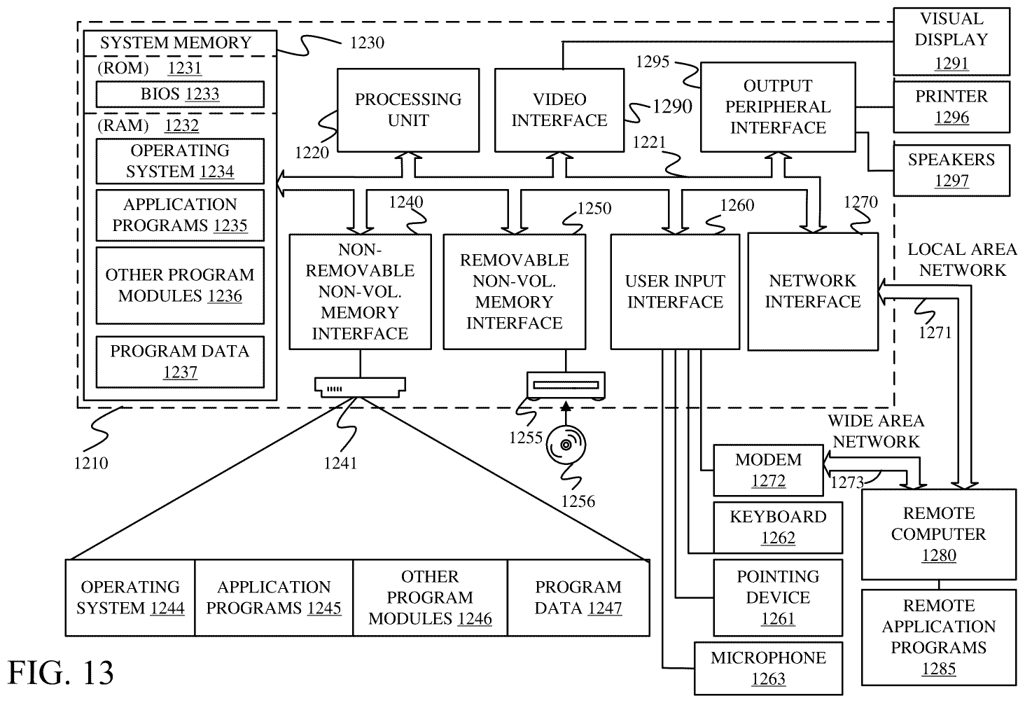

FIG. 13 is one example of a computing environment in which elements of previous figures described herein can be deployed. With reference to FIG. 13, an example system for implementing some embodiments includes a computing device in the form of a computer 1210 14 programmed to operate as discussed above. Components of computer 1210 can include, but are not limited to, a processing unit 1220 (which can comprise processors or servers from previous figures), a system memory 1230, and a system bus 1221 that couples various system components including the system memory to the processing unit 1220. The system bus 1221 can be any of several types of bus structures including a memory bus or memory controller, a peripheral bus, and a local bus using any of a variety of bus architectures. Memory and programs described with respect to previous figures described herein can be deployed in corresponding portions of FIG. 13.

Computer 1210 typically includes a variety of computer readable media. Computer readable media can be any available media that can be accessed by computer 1210 and includes both volatile and nonvolatile media, removable and non-removable media. By way of example, and not limitation, computer readable media can comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1210. Communication media can embody computer readable instructions, data structures, program modules or other data in a transport mechanism and includes any information delivery media. The term “modulated data signal” means a signal that has one or more of its characteristics set or changed in such a manner as to encode information in the signal.

The system memory 1230 includes computer storage media in the form of volatile and/or nonvolatile memory or both such as read only memory (ROM) 1231 and random access memory (RAM) 1232. A basic input/output system 1233 (BIOS), containing the basic routines that help to transfer information between elements within computer 1210, such as during start-up, is typically stored in ROM 1231. RAM 1232 typically contains data or program modules or both that are immediately accessible to and/or presently being operated on by processing unit 1220. By way of example, and not limitation, FIG. 13 illustrates operating system 1234, application programs 1235, other program modules 1236, and program data 1237.

The computer 1210 can also include other removable/non-removable volatile/nonvolatile computer storage media. By way of example only, FIG. 13 illustrates a hard disk drive 1241 that reads from or writes to non-removable, nonvolatile magnetic media, an optical disk drive 1255, and nonvolatile optical disk 1256. The hard disk drive 1241 is typically connected to the system bus 1221 through a non-removable memory interface such as interface 1240, and optical disk drive 1255 are typically connected to the system bus 1221 by a removable memory interface, such as interface 1250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), quantum computers, etc.

The drives and their associated computer storage media discussed above and illustrated in FIG. 13 provide storage of computer readable instructions, data structures, program modules and other data for the computer 1210. In FIG. 13, for example, hard disk drive 1241 is illustrated as storing operating system 1244, application programs 1245, other program modules 1246, and program data 1247. Note that these components can either be the same as or different from operating system 1234, application programs 1235, other program modules 1236, and program data 1237.

A user can enter commands and information into the computer 1210 through input devices such as a keyboard 1262, a microphone 1263, and a pointing device 1261, such as a mouse, trackball or touch pad. Other input devices (not shown) can include a joystick, game pad, satellite dish, scanner, or the like. These and other input devices are often connected to the processing unit 1220 through a user input interface 1260 that is coupled to the system bus, but can be connected by other interface and bus structures. A visual display 1291 or other type of display device is also connected to the system bus 1221 via an interface, such as a video interface 1290. In addition to the monitor, computers can also include other peripheral output devices such as speakers 1297 and printer 1296, which can be connected through an output peripheral interface 1295.

The computer 1210 is operated in a networked environment using logical connections (such as a controller area network-CAN, local area network-LAN, or wide area network WAN) to one or more remote computers, such as a remote computer 1280.

When used in a LAN networking environment, the computer 1210 is connected to the LAN 1271 through a network interface or adapter 1270. When used in a WAN networking environment, the computer 1210 typically includes a modem 1272 or other means for establishing communications over the WAN 1273, such as the Internet. In a networked environment, program modules can be stored in a remote memory storage device. FIG. 13 illustrates, for example, that remote application programs 1285 can reside on remote computer 1280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

While various spatial and directional terms, including but not limited to top, bottom, lower, mid, lateral, horizontal, vertical, front and the like are used to describe the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

Various operations of implementations are provided herein. In one implementation, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each implementation provided herein.

Any range or value given herein can be extended or altered without losing the effect sought, as will be apparent to the skilled person.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device, carrier or media. Of course, those skilled in the art will recognize many modifications may be made to this configuration without departing from the scope or spirit of the claimed subject matter.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this disclosure. It is intended to include all such modifications and alterations in so far as they come within the scope of the appended claims or the equivalents thereof.

What is claimed is:

1. An agricultural system for controlling an agricultural work machine:
one or more processors; and
memory storing instructions executable by the one or more processors that, when executed by the one or more processors, cause the agricultural system to:
identify that a responsiveness evaluation is to be conducted, based on responsiveness evaluation criteria;
obtain first sensed data representative of one or more performance parameters of the agricultural work machine;
generate, in response to the identification that the responsiveness evaluation is to be conducted, a command to adjust, by a first adjustment value, an operational parameter of the agricultural work machine;
obtain second sensed data representative of the one or more performance parameters of the agricultural work machine, wherein the first sensed data is generated prior to the adjustment to the operational parameter of the agricultural work machine and wherein the second sensed data is generated after the adjustment to the operational parameter of the agricultural work machine;
compare the one or more performance parameters of the agricultural work machine, represented by the first sensor data, to the one or more performance parameters of the agricultural work machine, represented by the second sensor data;
generate a threshold target value for use in adjusting the operational parameter of the agricultural work machine based on the comparison; and
control the agricultural work machine based, at least, on the threshold target value.

2. The agricultural system of claim 1, wherein the responsiveness evaluation criteria comprises one or more of: (i) a time interval; (ii) a distance traveled; (iii) a characteristic of the worksite; (iv) an amount of area of the worksite worked; (iv) an amount of material at the worksite worked; or (vi) a variability of a characteristic of the worksite.

3. The agricultural system of claim 1, wherein the agricultural work machine comprises a harvester, wherein the one or more performance parameters comprise a residue performance parameter; and wherein the operational parameter comprises an operational parameter corresponding to a component of a residue system of the harvester.

4. The agricultural system of claim 1, wherein the agricultural work machine comprises a harvester, wherein the one or more performance parameters comprise a residue performance parameter and a power consumption performance parameter; and wherein the operational parameter comprises an operational parameter corresponding to a component of a residue system of the harvester.

5. The agricultural system of claim 1, wherein the instructions, when executed by the one or more processors, cause the agricultural system to:
obtain third sensed data representative of the performance parameter of the agricultural work machine; and
control the agricultural work machine based, at least, on the threshold target value and the performance parameter of the agricultural work machine represented by the third sensed data.

6. The agricultural system of claim 1, wherein the instructions, when executed by the one or more processors, cause the agricultural system to:
generate, based on the comparison, as the threshold target value, a value representing the difference between the one or more performance parameters of the agricultural work machine, represented by the first sensor data, and the one or more performance parameters of the agricultural work machine, represented by the second sensor data.

7. The agricultural system of claim 1, wherein the instructions, when executed by the one or more processors, cause the agricultural system to:
generate, based on the comparison, as the threshold target value, a proportional value representing a portion of a difference between the one or more performance parameters of the agricultural work machine, represented by the first sensor data, and the one or more performance parameters of the agricultural work machine, represented by the second sensor data.

8. The agricultural system of claim 1, wherein the instructions, when executed by the one or more processors, cause the agricultural system to:
generate, based on the comparison, a second adjustment value corresponding to the threshold target value for use in adjusting the operational parameter of the agricultural work machine; and
control the agricultural work machine based, at least, on the threshold target value and the corresponding second adjustment value.

9. The agricultural system of claim 8, wherein the second adjustment value is different than the first adjustment value.

10. The agricultural system of claim 9, wherein the second adjustment value is a proportional value representing a portion of the first adjustment value.

11. The agricultural system of claim 9, wherein the second adjustment value is different from the first adjustment value by an amount, the amount based on a difference between the one or more performance parameters of the agricultural work machine, represented by the first sensor data, to the one or more performance parameters of the agricultural work machine, represented by the second sensor data.

12. A computer implemented method for controlling an agricultural work machine, the method comprising:
identifying that a responsiveness evaluation is to be conducted, based on responsiveness evaluation criteria;
obtaining first sensed data representative of one or more performance parameters of the agricultural work machine;
generating, in response to the identification that the responsiveness evaluation is to be conducted, a command to adjust, by a first adjustment value, an operational parameter of the agricultural work machine;
obtaining second sensed data representative of the one or more performance parameters of the agricultural work machine, wherein the first sensed data is generated prior to the adjustment to the operational parameter of the agricultural work machine and wherein the second sensed data is generated after the adjustment to the operational parameter of the agricultural work machine;
comparing the one or more performance parameters of the agricultural work machine, represented by the first sensor data, to the one or more performance parameters of the agricultural work machine, represented by the second sensor data;
generating a threshold target value for use in adjusting the operational parameter of the agricultural work machine based on the comparison;
controlling the agricultural work machine based, at least, on the threshold target value.

13. The computer implemented method of claim 12 and further comprising:
obtaining third sensed data representative of the performance parameter of the agricultural work machine; and
controlling the agricultural work machine based, at least, on the threshold target value and the performance parameter of the agricultural work machine represented by the third sensed data.

14. The computer implemented method of claim 12, wherein generating the threshold target value comprises:
generating, based on the comparison, as the threshold target value, a value representing the difference between the one or more performance parameters of the agricultural work machine, represented by the first sensor data, and the one or more performance parameters of the agricultural work machine, represented by the second sensor data.

15. The computer implemented method of claim 12, wherein generating the threshold target value comprises:
generating, based on the comparison, as the threshold target value, a proportional value representing a portion of a difference between the one or more performance parameters of the agricultural work machine, represented by the first sensor data, and the one or more performance parameters of the agricultural work machine, represented by the second sensor data.

16. The computer implemented method of claim 12, wherein generating the threshold target value comprises:
generating, based on the comparison, a second adjustment value corresponding to the threshold target value for use in adjusting the operational parameter of the agricultural work machine; and
control the agricultural work machine based, at least, on the threshold target value and the corresponding second adjustment value.

17. An agricultural work machine comprising:
one or more sensors configured to detect one or more performance parameters of the agricultural work machine and generate sensed data indicative of the one or more performance parameters;
one or more processors; and
memory storing instructions, executable by the one or more processors that, when executed by the one or more processors, cause the agricultural work machine to:
identify that a responsiveness evaluation is to be conducted, based on responsiveness evaluation criteria;
obtain first sensed data representative of one or more performance parameters of the agricultural work machine;
generate, in response to the identification that the responsiveness evaluation is to be conducted, a command to adjust, by a first adjustment value, an operational parameter of the agricultural work machine;
obtain second sensed data representative of the one or more performance parameters of the agricultural work machine, wherein the first sensed data is generated prior to the adjustment to the operational parameter of the agricultural work machine and wherein the second sensed data is generated after the adjustment to the operational parameter of the agricultural work machine;
compare the one or more performance parameters of the agricultural work machine, represented by the first sensor data, to the one or more performance parameters of the agricultural work machine, represented by the second sensor data;
generate a threshold target value for use in adjusting the operational parameter of the agricultural work machine based on the comparison;
control the agricultural work machine based, at least, on the threshold target value.

18. The agricultural work machine of claim 17, wherein the instructions, when executed by the one or more processors, cause the agricultural work machine to:
generate, based on the comparison, as the threshold target value, a value representing the difference between the one or more performance parameters of the agricultural work machine, represented by the first sensor data, and the one or more performance parameters of the agricultural work machine, represented by the second sensor data.

19. The agricultural work machine of claim 17, wherein the instructions, when executed by the one or more processors, cause the agricultural work machine to:
generate, based on the comparison, as the threshold target value, a proportional value representing a portion of a difference between the one or more performance parameters of the agricultural work machine, represented by the first sensor data, and the one or more performance parameters of the agricultural work machine, represented by the second sensor data.

20. The agricultural work machine of claim 17, wherein the instructions, when executed by the one or more processors, cause the agricultural work machine to:
generate, based on the comparison, a second adjustment value corresponding to the threshold target value for use in adjusting the operational parameter of the agricultural work machine; and
control the agricultural work machine based, at least, on the threshold target value and the corresponding second adjustment value.
